(19) United States
(12) Patent Application Publication
(10) Pub. No.: US 2026/0046201 A1
(43) Pub. Date: Feb. 12, 2026

(54) LOCATION-BASED ZERO-TOUCH PROVISIONING SYSTEM

(71) Applicant: Dell Products L.P., Round Rock, TX (US)

(72) Inventors: Padmanabhan Narayanan, Chennai (IN); Shree Rathinasamy, Georgetown, TX (US); Maxim Balin, Gan-Yavne (IL); Senthil Kumar Ganesan, San Ramon, CA (US)

(21) Appl. No.: 18/800,303

(22) Filed: Aug. 12, 2024

(51) Int. Cl. H04L 41/0806; H04W 4/021; H04W 12/03

(52) U.S. Cl. CPC H04L 41/0806; H04W 4/021; H04W 12/03

(57) ABSTRACT

A location-based zero-touch provisioning system includes a first computing device that is located at a first location, and a configuration provisioning system that is coupled to the first computing device. The configuration provisioning system receives first location information from the first computing device identifying the first location of the first computing device. The configuration provision system then identifies a first configuration that is mapped to the first location information in a configuration/location mapping included in a configuration provisioning database. The configuration provisioning system then provides the first configuration to the first computing device to configure the first computing device with the first configuration.

### BACKGROUND

The present disclosure relates generally to information handling systems, and more particularly to the “zero-touch” provisioning of information handling systems based on their location.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices, networking devices (e.g., switch devices, router devices, etc.), storage systems, and/or other computing devices known in the art, require configuration during their deployment in order to operate in a desired manner. In many situations, such configurations may be provided using “Zero-Touch Provisioning” (ZTP) techniques that one of skill in the art will recognize provide for the remote configuration of relatively large numbers of computing devices in less time and with fewer errors than manual per-computing-device configuration provisioning techniques. However, conventional ZTP techniques suffer from several issues.

For example, conventional ZTP techniques require a network administrator or other user to provide computing device identification information (e.g., a base Media Access Control (MAC) address, service tag, serial number, and/or other identification information specific to that computing device) in a ZTP server device for each computing device being configured, and then associate the computing device identification information for each computing device with a desired configuration for that computing device in the ZTP server device. As will be appreciated by one of skill in the art, such configuration operations are cumbersome, particularly when a relatively large number of computing devices must be deployed (i.e., with each computing device requiring the association of its desired configuration with its computing-device-identification information in the ZTP server device), or when existing computing devices must be replaced (i.e., requiring the association of the configuration that had been applied to the existing computing device with the computing device identification information for the replacement computing device in the ZTP server device).

Accordingly, it would be desirable to provide ZTP system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a configuration provisioning engine that is configured to: receive, from a first computing device, first location information identifying a first location at which the first computing device is located; identify, in a configuration/location mapping included in a configuration provisioning database, a first configuration that is mapped to the first location information; and provide, to the first computing device, the first configuration to configure the first computing device with the first configuration.

### BRIEF DESCRIPTION OF THE DRAWINGS

FIG. 1 is a schematic view illustrating an embodiment of an Information Handling System (IHS).

FIG. 2 is a schematic view illustrating an embodiment of a location-based zero-touch provisioning system that may be provided according to the teachings of the present disclosure.

FIG. 3A is a schematic view illustrating an embodiment of a rack that may provide one or more locations in the location-based zero-touch provisioning system of FIG. 2.

FIG. 3B is a schematic view illustrating an embodiment of a rack that may provide one or more locations in the location-based zero-touch provisioning system of FIG. 2.

FIG. 4 is a schematic view illustrating an embodiment of a computing device that may be provided in the location-based zero-touch provisioning system of FIG. 2.

FIG. 5A is a schematic view illustrating an embodiment of the computing device of FIG. 4.

FIG. 5B is a schematic view illustrating an embodiment of the computing device of FIG. 4.

FIG. 6A is a schematic view illustrating an embodiment of a configuration provisioning system that may be provided in the location-based zero-touch provisioning system of FIG. 2.

FIG. 6B is a schematic view illustrating an embodiment of a configuration provisioning database that may be provided in the configuration provisioning system of FIG. 6A.

FIG. 7 is a flow chart illustrating an embodiment of a method for performing zero-touch provisioning of computing devices based on locations of those computing devices.

FIG. 8 is a schematic view illustrating an embodiment of a plurality of the computing devices of FIG. 4 provided in the location-based zero-touch provisioning system of FIG. 2 during the method of FIG. 7.

FIG. 9 is a schematic view illustrating an embodiment of the computing device of FIG. 5B provided in the rack of FIG. 3A during the method of FIG. 7.

FIG. 10 is a schematic view illustrating an embodiment of the computing device of FIG. 5A provided in the rack of FIG. 3B during the method of FIG. 7.

FIG. 11A is a schematic view illustrating an embodiment of the configuration provisioning system of FIG. 6A operating during the method of FIG. 7.

FIG. 11B is a schematic view illustrating an embodiment of the location-based zero-touch provisioning system including the computing devices of FIG. 8 operating during the method of FIG. 7.

FIG. 11C is a schematic view illustrating an embodiment of the computing device of FIG. 5A operating during the method of FIG. 7.

FIG. 11D is a schematic view illustrating an embodiment of the computing device of FIG. 5A operating during the method of FIG. 7.

FIG. 11E is a schematic view illustrating an embodiment of the computing device of FIG. 5A operating during the method of FIG. 7.

FIG. 11F is a schematic view illustrating an embodiment of the computing device of FIG. 5A operating during the method of FIG. 7.

FIG. 11G is a schematic view illustrating an embodiment of the location-based zero-touch provisioning system including the computing devices of FIG. 8 operating during the method of FIG. 7.

FIG. 11H is a schematic view illustrating an embodiment of the configuration provisioning system of FIG. 6A operating during the method of FIG. 7.

FIG. 11I is a schematic view illustrating an embodiment of the configuration provisioning system of FIG. 6A operating during the method of FIG. 7.

FIG. 12A is a schematic view illustrating an embodiment of the configuration provisioning system of FIG. 6A operating during the method of FIG. 7.

FIG. 12B is a schematic view illustrating an embodiment of the location-based zero-touch provisioning system including the computing devices of FIG. 8 operating during the method of FIG. 7.

FIG. 12C is a schematic view illustrating an embodiment of the location-based zero-touch provisioning system including the computing devices of FIG. 8 operating during the method of FIG. 7.

FIG. 12D is a schematic view illustrating an embodiment of the location-based zero-touch provisioning system including the computing devices of FIG. 8 operating during the method of FIG. 7.

FIG. 12E is a schematic view illustrating an embodiment of the configuration provisioning system of FIG. 6A operating during the method of FIG. 7.

FIG. 12F is a schematic view illustrating an embodiment of the configuration provisioning system of FIG. 6A operating during the method of FIG. 7.

FIG. 13A is a schematic view illustrating an embodiment of the configuration provisioning system of FIG. 6A operating during the method of FIG. 7.

FIG. 13B is a schematic view illustrating an embodiment of the location-based zero-touch provisioning system including the computing devices of FIG. 8 operating during the method of FIG. 7.

FIG. 13C is a schematic view illustrating an embodiment of the computing device of FIG. 5B operating during the method of FIG. 7.

FIG. 13D is a schematic view illustrating an embodiment of the computing device of FIG. 5B operating during the method of FIG. 7.

FIG. 13E is a schematic view illustrating an embodiment of the location-based zero-touch provisioning system including the computing devices of FIG. 8 operating during the method of FIG. 7.

FIG. 13F is a schematic view illustrating an embodiment of the computing device of FIG. 5B operating during the method of FIG. 7.

FIG. 13G is a schematic view illustrating an embodiment of the computing device of FIG. 5B operating during the method of FIG. 7.

FIG. 13H is a schematic view illustrating an embodiment of the location-based zero-touch provisioning system including the computing devices of FIG. 8 operating during the method of FIG. 7.

FIG. 13I is a schematic view illustrating an embodiment of the configuration provisioning system of FIG. 6A operating during the method of FIG. 7.

FIG. 13J is a schematic view illustrating an embodiment of the configuration provisioning system of FIG. 6A operating during the method of FIG. 7.

FIG. 14 is a schematic view illustrating an embodiment of the location-based zero-touch provisioning system including the computing devices of FIG. 8 operating during the method of FIG. 7.

FIG. 15 is a schematic view illustrating an embodiment of the computing device of FIG. 5A operating during the method of FIG. 7.

FIG. 16 is a schematic view illustrating an embodiment of the computing device of FIG. 5B operating during the method of FIG. 7.

FIG. 17A is a schematic view illustrating an embodiment of the location-based zero-touch provisioning system including the computing devices of FIG. 8 operating during the method of FIG. 7.

FIG. 17B is a schematic view illustrating an embodiment of the configuration provisioning system of FIG. 6A operating during the method of FIG. 7.

FIG. 18A is a schematic view illustrating an embodiment of the computing device of FIG. 4 operating during the method of FIG. 7.

FIG. 18B is a schematic view illustrating an embodiment of the location-based zero-touch provisioning system including the computing devices of FIG. 8 operating during the method of FIG. 7.

FIG. 18C is a schematic view illustrating an embodiment of the configuration provisioning system of FIG. 6A operating during the method of FIG. 7.

FIG. 19 is a schematic view illustrating an embodiment of the configuration provisioning system of FIG. 6A operating during the method of FIG. 7.

FIG. 20A is a schematic view illustrating an embodiment of the configuration provisioning system of FIG. 6A operating during the method of FIG. 7.

FIG. 20B is a schematic view illustrating an embodiment of the location-based zero-touch provisioning system including the computing devices of FIG. 8 operating during the method of FIG. 7.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

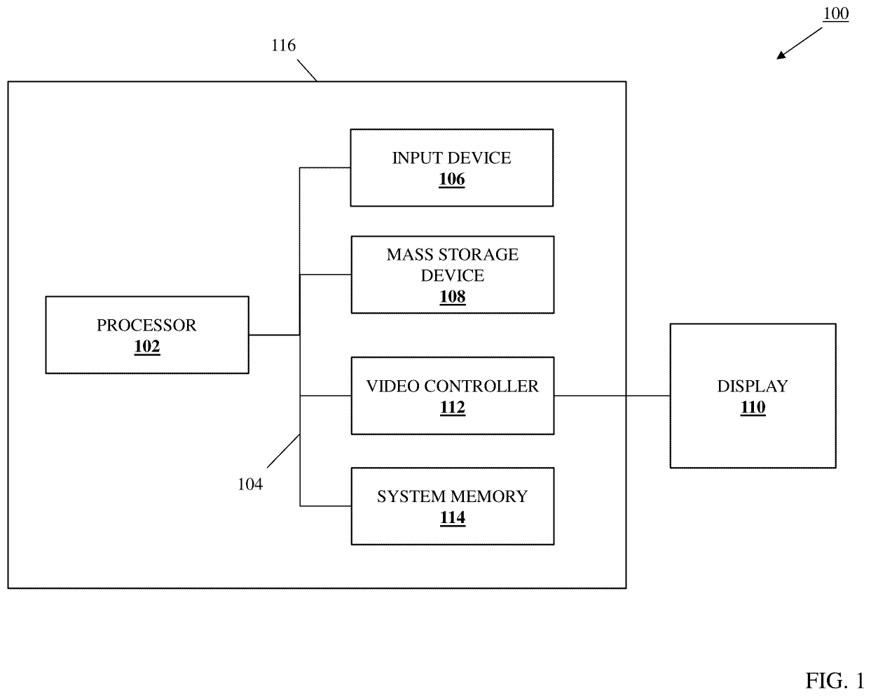

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

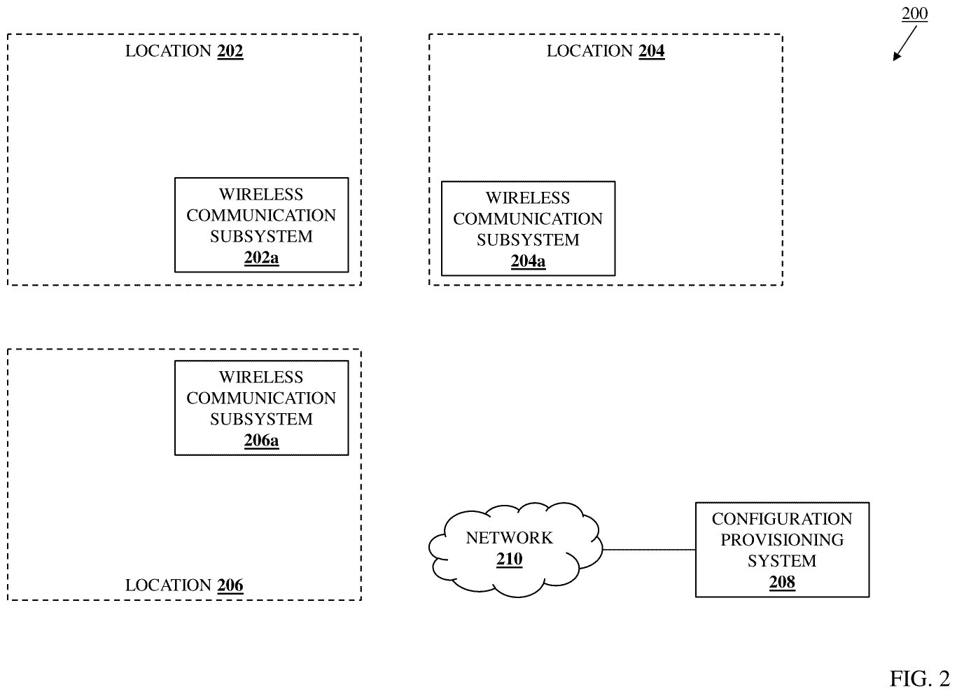

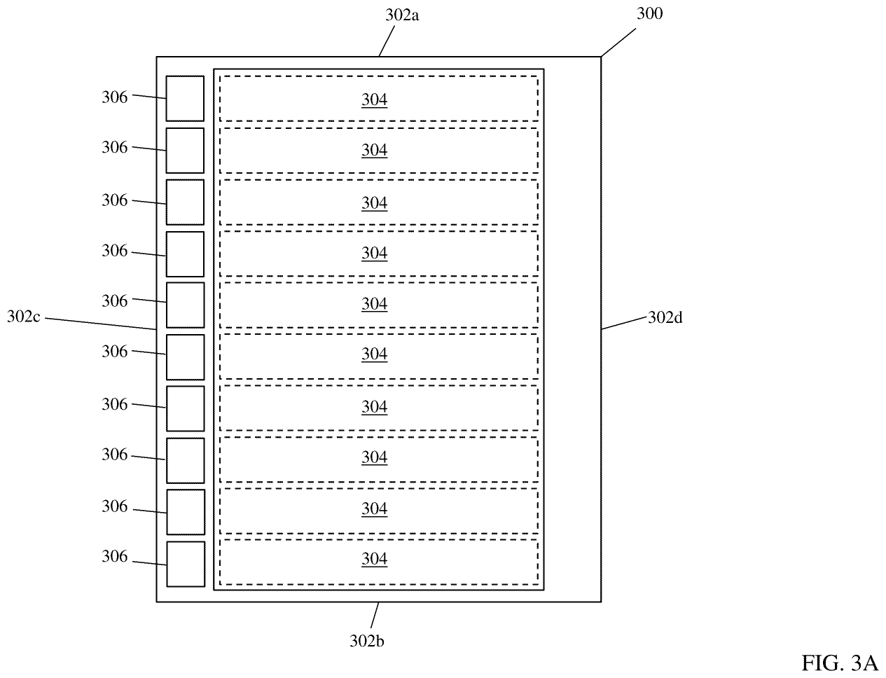

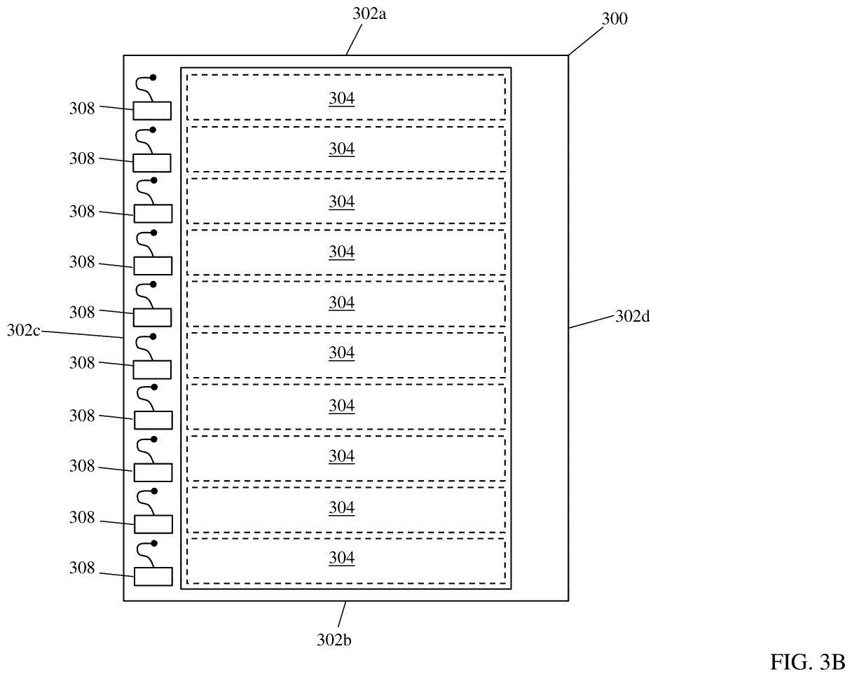

Referring now to FIG. 2, an embodiment of a location-based zero-touch provisioning system 200 that may be provided according to the teachings of the present disclosure is illustrated. In the illustrated embodiment, the location-based zero-touch provisioning system 200 includes a plurality of different locations 202, 204, and 206 that are illustrated and described below as being provided by different locations in one or more buildings and/or different locations in a rack, but one of skill in the art in possession of the present disclosure will appreciate how a variety of computing device locations will fall within the scope of the present disclosure. Furthermore, while only three locations are illustrated in FIG. 3, one of skill in the art in possession of the present disclosure will appreciate how any number of locations will fall within the scope of the present disclosure as well. Each of the locations 202, 204, and 206 includes a respective wireless communication subsystem 202a, 204a, and 206a, and, as described in further detail below, in different embodiments the wireless communication subsystem 202a-206a may be provided by wireless tags, wireless reader subsystems, and/or other wireless communications components that one of skill in the art in possession of the present disclosure will recognize as enabling the functionality discussed below.

The location-based zero-touch provisioning system 200 also includes a configuration provisioning system 208 that may be provided by the IHS 100 discussed above with reference to FIG. 1, may any include some or all of the components of the IHS 100, and in specific examples may be provided by one or more server devices (e.g., a Zero-Touch Provisioning (ZTP) server system including a Dynamic Host Configuration Protocol (DHCP) server subsystem). However, while illustrated and described as being provided by server device(s), one of skill in the art in possession of the present disclosure will appreciate how the configuration provisioning system 208 may be provided by other devices that are configured to operate similarly as the configuration provisioning system 208 described below.

As illustrated, the configuration provisioning system 208 is coupled to a network 210 that may be provided by a Local Area Network (LAN), the Internet, combinations thereof, and/or other networks that would be apparent to one of skill in the art in possession of the present disclosure. As described below, the network 210 may include wireless access points, switches wired to the wireless access points, configuration provisioning system 208, and computing devices described below, and/or other networking components that would be apparent to one of skill in the art in possession of the present disclosure. However, while a specific location-based zero-touch provisioning system 200 system has been illustrated and described, one of skill in the art in possession of the present disclosure will recognize that the location-based zero-touch provisioning system of the present disclosure may include a variety of components and component configurations for providing conventional zero-touch provisioning functionality, as well as the location-based zero-touch provisioning functionality described below, while remaining within the scope of the present disclosure as well.

Referring now to FIGS. 3A and 3B, different embodiments of a rack 300 that may provide one or more of the locations 202-206 discussed above with reference to FIG. 2 are illustrated. In the illustrated embodiment, the rack 300 includes a top wall 302a, a bottom wall 302b that is located opposite the rack 300 from the top wall 302a, and a pair of side walls 302c and 302d that each extend between the top wall 302a and the bottom wall 302b and that are located opposite the rack 300 from each other. As illustrated, a plurality of computing device housings 304 are defined by rack 300 between the top wall 302a, the bottom wall 302b, and the side walls 302c and 302d, and one of skill in the art in possession of the present disclosure will appreciate how the rack 300 may include coupling features (not illustrated) for coupling, securing, and/or otherwise providing computing devices in the computing devices housings 304 as illustrated and described below.

As described in further detail below, the embodiment of the rack 300 illustrated in FIG. 3A may be provided for use with computing devices that do not include wireless reader subsystems, with a respective wireless reader subsystem 306 (e.g., a Near Field Communication (NFC) reader subsystem or other wireless reader subsystem known in the art) provided on the side wall 302c adjacent each of the computing device housings 304 for use with wireless tags (e.g., NFC tags or other wireless tags known in the art) that may be provided on the computing devices as described below. For example, each respective wireless reader subsystem 306 may be affixed to the side wall 302c using adhesives, mechanical fastening devices, and/or any of a variety of techniques that would be apparent to one of skill in the art in possession of the present disclosure.

In some embodiments, each of the wireless reader subsystems 306 may store location information identifying the rack 300 (i.e., each of the wireless reader subsystems 306 may include the same location information discussed in further detail below). However, in other embodiments, each of the wireless reader subsystems 306 may store location information identifying its corresponding computing device housing 304 (i.e., each wireless reader subsystem 306 may store information identifying the computing device housing 304 to its immediate right in FIG. 3A), and one of skill in the art in possession of the present disclosure will appreciate how at least some location information stored in the wireless reader subsystems 306 in such embodiments may be different (e.g., the top two wireless reader subsystems 306 may store location information identifying a Top Of Rack (TOR) switch device location, while the remaining wireless reader subsystems 306 may store location information identifying server device locations, storage device locations, and/or other non-TOR switch device locations that would be apparent to one of skill in the art in possession of the present disclosure). Furthermore, as described below, in some embodiments the wireless reader subsystems 306 may be configured to perform communication encryption operations and/or other secure communication operations known in the art

As also described in further detail below, the embodiment illustrated in FIG. 3B may be provided for use with computing devices that include wireless reader subsystems, with a respective wireless tag 308 (e.g., an NFC tag or other wireless tags known in the art) provided on the side wall 302c adjacent each of the computing device housings 304 for use with wireless reader subsystem (e.g., NFC reader subsystems or other wireless reader subsystems known in the art) that may be included on the computing devices as described below. For example, each respective wireless tag 308 may be tethered to the side wall 302c using any of a variety of techniques that would be apparent to one of skill in the art in possession of the present disclosure. As described below, the tethering of wireless tags 308 to the rack 300 may allow the wireless tags 308 to move into engagement with wireless reader subsystems on computing devices when doing so is necessary to overcome interference issues and/or other issues (e.g., wireless transmission range issues) known in the art, but embodiments in which such issues do not exist, the wireless tags 308 may be affixed (e.g., adhered) to the rack 300 while remaining within the scope of the present disclosure as well.

In some embodiments, each of the wireless tags 308 may store location information identifying the rack 300 (i.e., each of the wireless tags 308 may include the same location information discussed in further detail below). However, in other embodiments each of the wireless tags 308 may store location information identifying its corresponding computing device housing 304 (i.e., each wireless tag 308 may store information identifying the computing device housing 304 to its immediate right in FIG. 3B), and one of skill in the art in possession of the present disclosure will appreciate how at least some location information stored in the wireless tags 308 may be different (e.g., the top two wireless tags 308 may store location information identifying a Top Of Rack (TOR) switch device location, while the remaining wireless tags 308 may store location information identifying server device locations, storage system locations, and/or other non-TOR switch device locations that would be apparent to one of skill in the art in possession of the present disclosure). Furthermore, as described below, in some embodiments the wireless tags 308 may be configured to perform communication encryption operations and/or other secure communication operations known in the art.

Furthermore, while FIGS. 3A and 3B provide several specific examples of locations and wireless communication subsystems, a wide variety of modification to those examples will fall within the scope of the present disclosure as well. For example, some embodiments may include each rack providing a single location with a single wireless communication subsystem that is configured to wirelessly communicate with each computing device in that rack, and as described above locations each having a corresponding wireless communication subsystem for a single computing device (e.g., respective locations in a building at which a computing device will be used and will require a particular configuration) will fall within the scope of the present disclosure as well. As such, the location-based zero-touch provisioning system may include any of a variety of locations that may be provided with the wireless communications subsystems similarly as described below while remaining within the scope of the present disclosure,

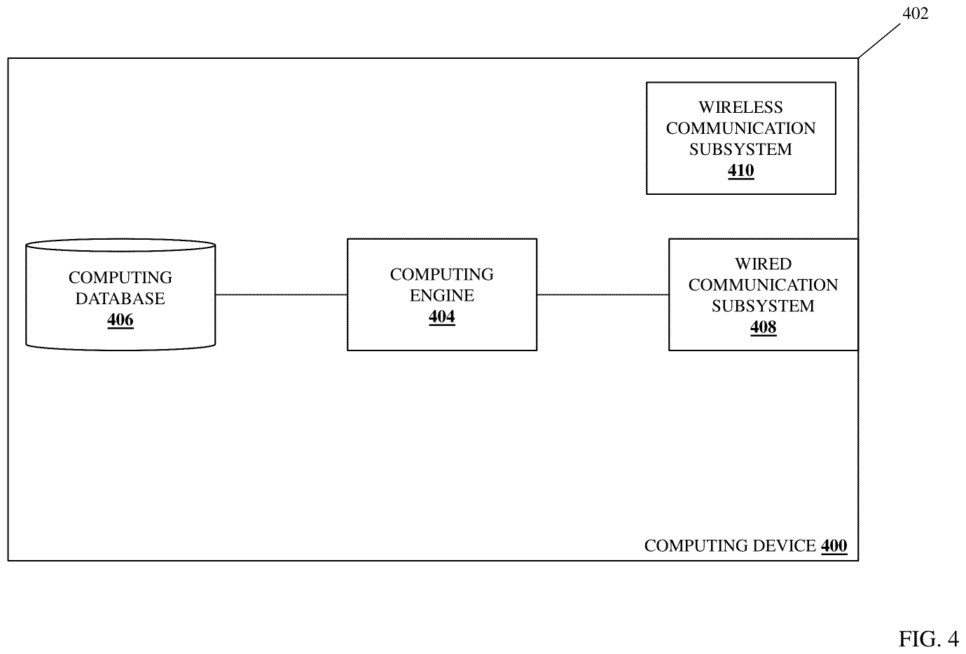

Referring now to FIG. 4, an embodiment of a computing device 400 is illustrated that may be used with the location-based zero-touch provisioning system 200 discussed above with reference to FIG. 2. In an embodiment, the computing device 400 may be provided by the IHS 100 discussed above with reference to FIG. 1 and/or may include some or all of the components of the IHS 100, and in specific examples may be provided by server devices, networking devices (e.g., switch device, router devices, etc.), storage systems, and/or other computing devices known in the art. However, while illustrated and discussed as being provided by particular computing devices, one of skill in the art in possession of the present disclosure will recognize that the functionality of the computing device 400 discussed below may be provided by other devices that are configured to operate similarly as the computing device 400 discussed below.

In the illustrated embodiment, the computing device 400 includes a chassis 402 that houses the components of the computing device 400, only some of which are illustrated and described below. For example, the chassis 402 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a computing engine 404 that is configured to perform the functionality of the computing engines and/or computing devices discussed below.

The chassis 402 may also house a storage system (not illustrated, but which may include the storage 108 discussed above with reference to FIG. 1) that is coupled to the computing engine 404 (e.g., via a coupling between the storage system and the processing system) and that includes a computing database 406 that is configured to store any of the information utilized by the computing engine 404 discussed below. The chassis 402 may also house a wired communication subsystem 408 that is coupled to the computing engine 404 (e.g., via a coupling between the communication system 308 and the processing system) and that may be provided by a Network Interface Controller (NIC) and/or any other wired communication components that would be apparent to one of skill in the art in possession of the present disclosure.

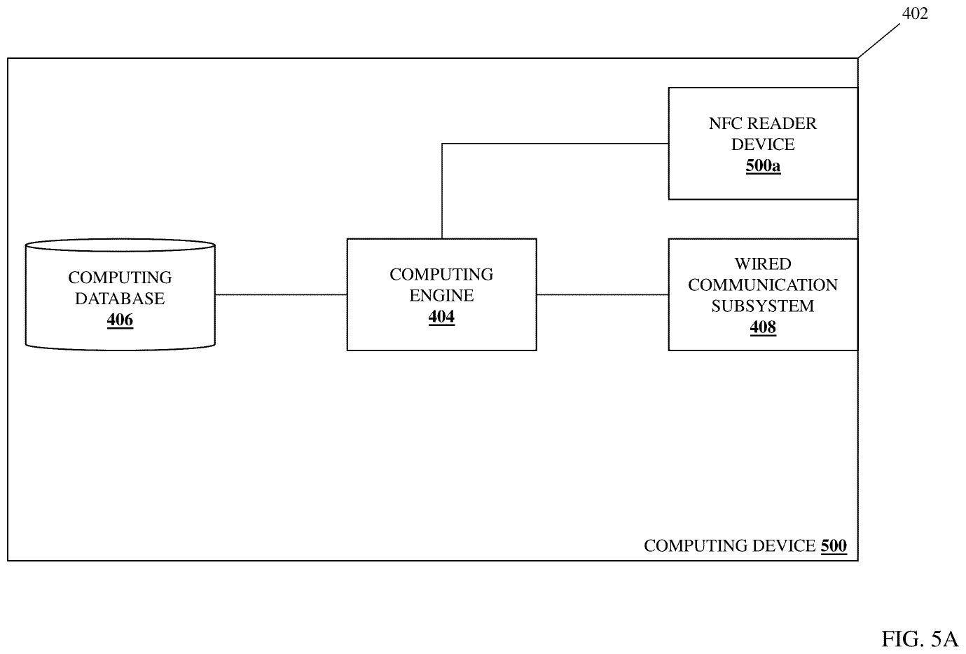

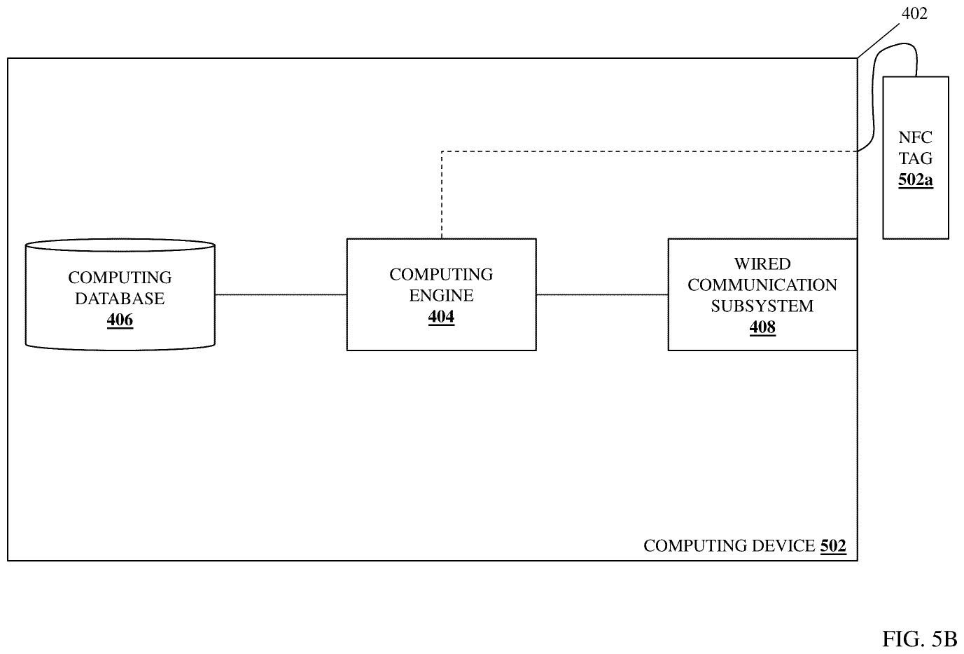

The chassis 402 may also house a wireless communication subsystem 410 that, in different embodiments of the present disclosure, may be provided by different wireless communication components. For example, with reference to FIG. 5A, a computing device 500 is illustrated that is substantially similar to the computing device 400 discussed above with reference to FIG. 4, with similar elements provided with the same element numbers. As will be appreciated by one of skill in the art in possession of the present disclosure, the wireless communication subsystem 410 in the computing device 400 is provided in the computing device 500 by an NFC reader device 500a (or other wireless reader subsystem known in the art) that is coupled to the computing engine 404 (e.g., via a coupling between the NFC reader device 500a and the processing system) and that is configured to read the NFC tags described below that may be provided at locations in the location-based zero-touch provisioning system 200 discussed above with reference to FIG. 2. As will be appreciated by one of skill in the art in possession of the present disclosure, in some embodiments the computing device 500 may be manufactured with the NFC reader subsystem 500a for use with the location-based zero-touch provisioning system 200 of the present disclosure.

In another example, with reference to FIG. 5B, a computing device 502 is illustrated that is substantially similar to the computing device 400 discussed above with reference to FIG. 4, with similar elements provided with the same element numbers. As will be appreciated by one of skill in the art in possession of the present disclosure, the wireless communication subsystem 410 in the computing device 400 is provided in the computing device 502 by an NFC tag 502a (or other wireless tag known in the art) that is configured to store the computing device identification information described below that may be provided to NFC reader subsystems (or other wireless reader subsystems known in the art) at locations in the location-based zero-touch provisioning system 200 discussed above with reference to FIG. 2. Furthermore, as described below, in some embodiments the NFC tag 502a may be configured to perform communication encryption operations and/or other secure communication operations known in the art. As illustrated and described below, the NFC tag 502 may be tethered to the chassis 402 of the computing device 502, and in specific examples may be provided by a “luggage tag” for the computing device 502 upon which computing device identification information is printed (i.e., along with that computing device identification information also being stored in, and wirelessly readable via, the NFC tag 502a).

As discussed below, the tethering of the NFC tag 502a to the chassis 402 of the computing device 502 may allow the NFC tag 502a to move into engagement with wireless reader subsystems at locations in the location-based zero-touch provisioning system 200 when doing so is necessary to overcome interference issues and/or other issues (e.g., wireless transmission range issues) known in the art, but embodiments in which such issues do not exist and the NFC tag 502a is affixed (e.g., adhered) to the chassis 402 of the computing device 502 will fall within the scope of the present disclosure as well. As will be appreciated by one of skill in the art in possession of the present disclosure, in some embodiments the NFC tag 502a may be added to the computing device 502 (e.g., following its manufacture) to adapt it for use with the location-based zero-touch provisioning system 200 of the present disclosure.

In some embodiments, the NFC tag 502a of the computing device 502 may be provided by a Quick Asset Access Tag (QAAT) described by inventors of the present disclosure in U.S. patent application Ser. No. 18/436,444, attorney docket no. 135003.01, filed on Feb. 8, 2024, the disclosure of which is incorporated by reference herein in its entirety, and that QAAT may be connected (e.g., via a wired connection) to the computing engine 404 (as illustrated by the dashed line in FIG. 5B that represents a communication connection that is provided between the computing engine 404 and the NFC tag 502a/QAAT in such embodiments, but that need not be provided in non-QAAT embodiments). As described in that patent document, a QAAT may store computing device identification information for the computing device 502, and allows an NFC reader subsystem to wirelessly read information from the QAAT or write information to the QAAT. However, while several specific examples of the computing device 400 have been illustrated and described, one of skill in the art in possession of the present disclosure will recognize that computing devices (or other devices operating according to the teachings of the present disclosure in a manner similar to that described below for the computing device 400) may include a variety of components and/or component configurations for providing conventional computing device functionality, as well as the location-based zero-touch provisioning functionality discussed below, while remaining within the scope of the present disclosure as well.

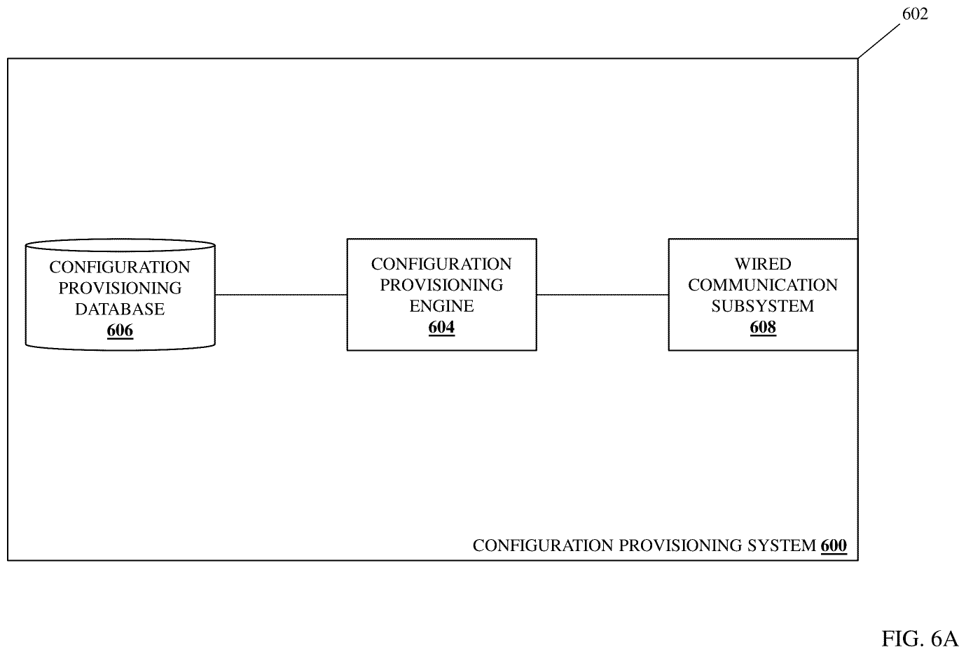

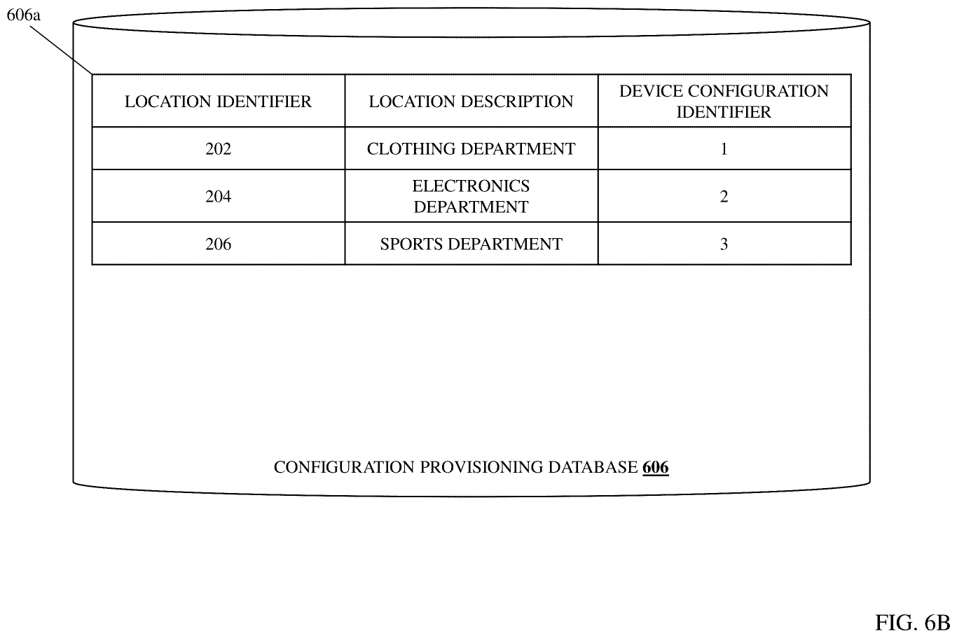

Referring now to FIG. 6, an embodiment of a configuration provisioning system 600 is illustrated that may provide the configuration provisioning system 208 in the location-based zero-touch provisioning system 200 discussed above with reference to FIG. 2. As such, the configuration provisioning system 600 may be provided by the IHS 100 discussed above with reference to FIG. 1 and/or may include some or all of the components of the IHS 100, and in specific examples may be provided by one or more server devices (e.g., a ZTP server system including a DHCP server subsystem). However, while illustrated and discussed as being provided by server device(s), one of skill in the art in possession of the present disclosure will recognize that the functionality of the configuration provisioning system 600 discussed below may be provided by other devices that are configured to operate similarly as the configuration provisioning system 600 discussed below.

In the illustrated embodiment, the configuration provisioning system 600 includes a chassis 602 that houses the components of the configuration provisioning system 600, only some of which are illustrated and described below. For example, the chassis 602 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a configuration provisioning engine 604 that is configured to perform the functionality of the configuration provisioning engines and/or configuration provisioning system discussed below.

The chassis 602 may also house a storage system (not illustrated, but which may include the storage 108 discussed above with reference to FIG. 1) that is coupled to the configuration provisioning engine 604 (e.g., via a coupling between the storage system and the processing system) and that includes a configuration provisioning database 606 that is configured to store any of the information utilized by the configuration provisioning engine 604 discussed below. With reference to FIG. 6B, an embodiment of the configuration provisioning database 606 is illustrated including a location/configuration mapping 606a that is used in one of the examples described below, and that includes a “LOCATION IDENTIFIER” column, a “LOCATION DESCRIPTION” column, and a “DEVICE CONFIGURATION IDENTIFIER”column.

As will be appreciated by one of skill in the art in possession of the present disclosure, the location/configuration mapping 606a may be provided in the configuration provisioning database 600 by a network administrator or other user of the location-based zero-touch provisioning system, with each row of the location/configuration mapping 606a mapping a location in the location-based zero-touch provisioning system to a configuration for devices at that location. In the illustrated example, the first row maps the location 202 discussed above with reference to FIG. 2 (e.g., identified as the “CLOTHING DEPARTMENT” in the “LOCATION DESCRIPTION” column) to a first configuration (e.g., device configuration “1” in the “DEVICE CONFIGURATION IDENTIFIER” column), the second row maps the location 204 discussed above with reference to FIG. 2 (e.g., identified as the “ELECTRONICS DEPARTMENT” in the “LOCATION DESCRIPTION” column) to a second configuration (e.g., device configuration “2” in the “DEVICE CONFIGURATION IDENTIFIER” column), and the third row maps the location 206 discussed above with reference to FIG. 2 (e.g., identified as the “SPORTS DEPARTMENT” in the “LOCATION DESCRIPTION” column) to a third configuration (e.g., device configuration “3” in the “DEVICE CONFIGURATION IDENTIFIER” column), and one of skill in the art in possession of the present disclosure will appreciate how the device configuration information for the device configurations identified in the “DEVICE CONFIGURATION IDENTIFIER” column may be stored in the configuration provisioning database and/or other databases that are accessible to the configuration provisioning engine 604.

As will be appreciated by one of skill in the art in possession of the present disclosure, the location/configuration mapping 606a provides one example of a situation in which the configurations of computing devices are specific to their physical locations, but other physical-location-specific computing device configuration situations will fall within the scope of the present disclosure as well. Furthermore, one of skill in the art in possession of the present disclosure will appreciate that the provisioning of the location/configuration mapping in the configuration provisioning database of the present disclosure need only be performed once as long as the configurations for computing devices at locations in the location-based zero-touch provisioning system of the present disclosure do not change.

The chassis 602 may also house a wired communication system 608 that is coupled to the configuration provisioning engine 604 (e.g., via a coupling between the communication system 608 and the processing system) and that may be provided by a Network Interface Controller (NIC) and/or any other wired communication components that would be apparent to one of skill in the art in possession of the present disclosure. However, while a specific configuration provisioning system 600 has been illustrated and described, one of skill in the art in possession of the present disclosure will recognize that configuration provisioning systems (or other devices operating according to the teachings of the present disclosure in a manner similar to that described below for the configuration provisioning system 600) may include a variety of components and/or component configurations for providing conventional configuration system functionality, as well as the location-based zero-touch provisioning functionality discussed below, while remaining within the scope of the present disclosure as well.

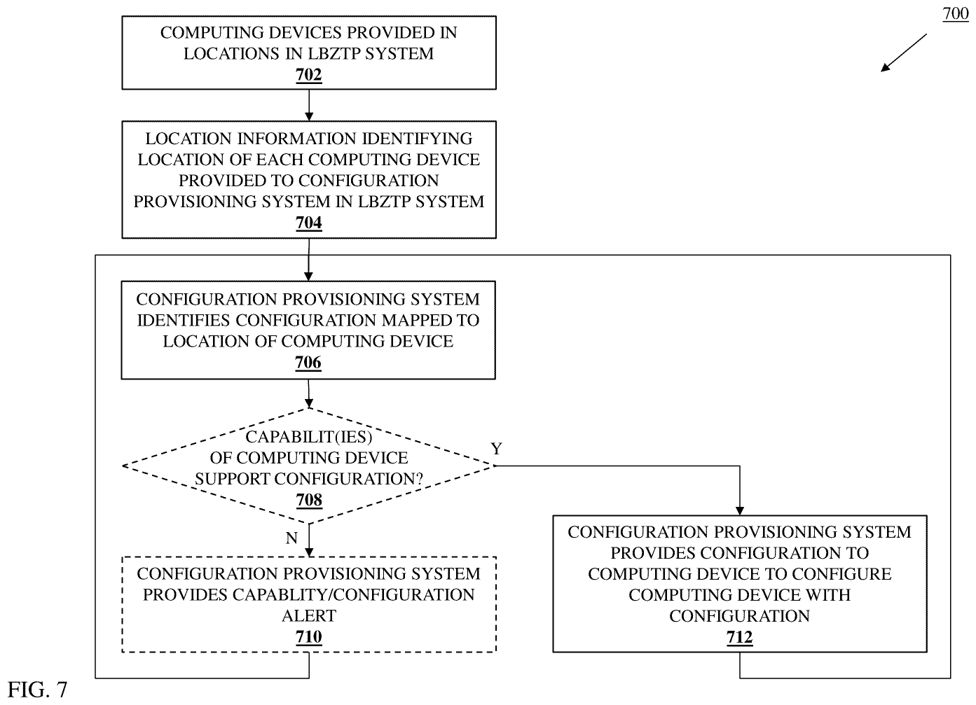

Referring now to FIG. 7, an embodiment of a method 700 for performing zero-touch provisioning of computing devices based on locations of those computing devices is illustrated. As discussed below, the systems and methods of the present disclosure identify configurations for computing devices based on the physical locations of those computing devices. For example, the location-based zero-touch provisioning system of the present disclosure may include a first computing device that is located at a first location, and a configuration provisioning system that is coupled to the first computing device. The configuration provisioning system receives first location information from the first computing device identifying the first location of the first computing device. The configuration provision system then identifies a first configuration that is mapped to the first location information in a configuration/location mapping included in a configuration provisioning database. The configuration provisioning system then provides the first configuration to the first computing device to configure the first computing device with the first configuration. As such, any computing device may be configured in a particular manner based on its particular physical location and without the need to map the identity of that computing device to its configuration.

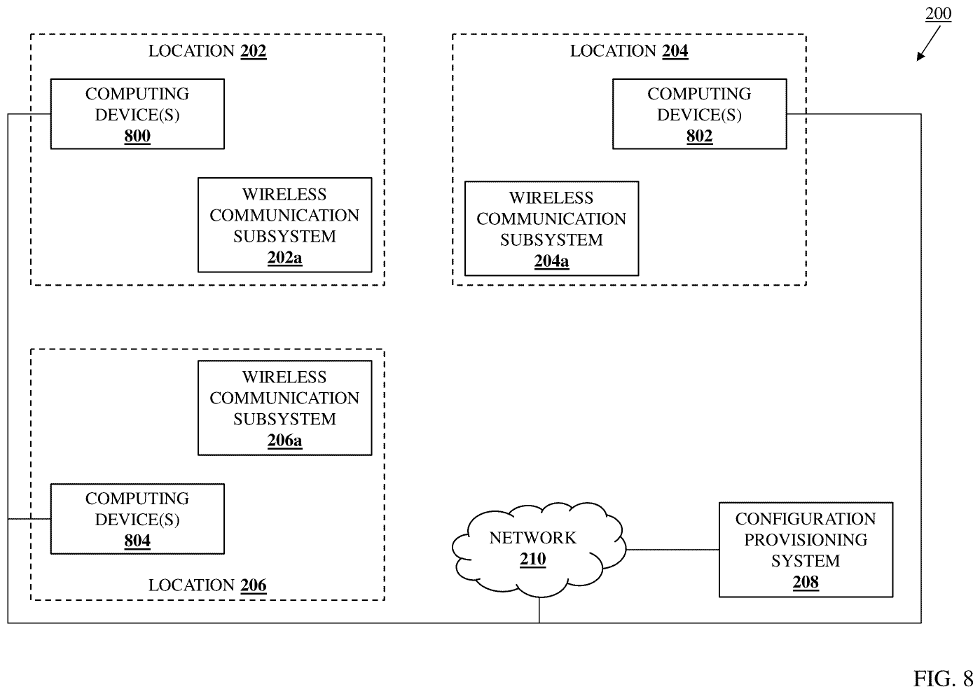

The method 700 begins at block 702 where computing devices are provided in locations in a location-based zero-touch provisioning system. With reference to FIG. 8, in an embodiment of block 702, one or more computing devices 800 may be provided in the location 202 and coupled to the network 210 (e.g., by cabling the wired communication subsystem 408 in that computing device 800/400 to a switch device or other network access device in the network 210), one or more computing devices 802 may be provided in the location 204 and coupled to the network 210 (e.g., by cabling the wired communication subsystem 408 in that computing device 802/400 to a switch device or other network access device in the network 210), and one or more computing devices 804 may be provided in the location 202 and coupled to the network 210 (e.g., by cabling the wired communication subsystem 408 in that computing device 804/400 to a switch device or other network access device in the network 210). In one of the specific examples discussed below, the locations 202, 204, and 206 are provided by different areas in a retail space, with the computing device(s) 800 provided in a clothing department in the retail space that provides the location 202, the computing device(s) 802 provided in an electronics department in the retail space that provides the location 204, and the computing device(s) 804 provided in a sports department in the retail space that provides the location 204.

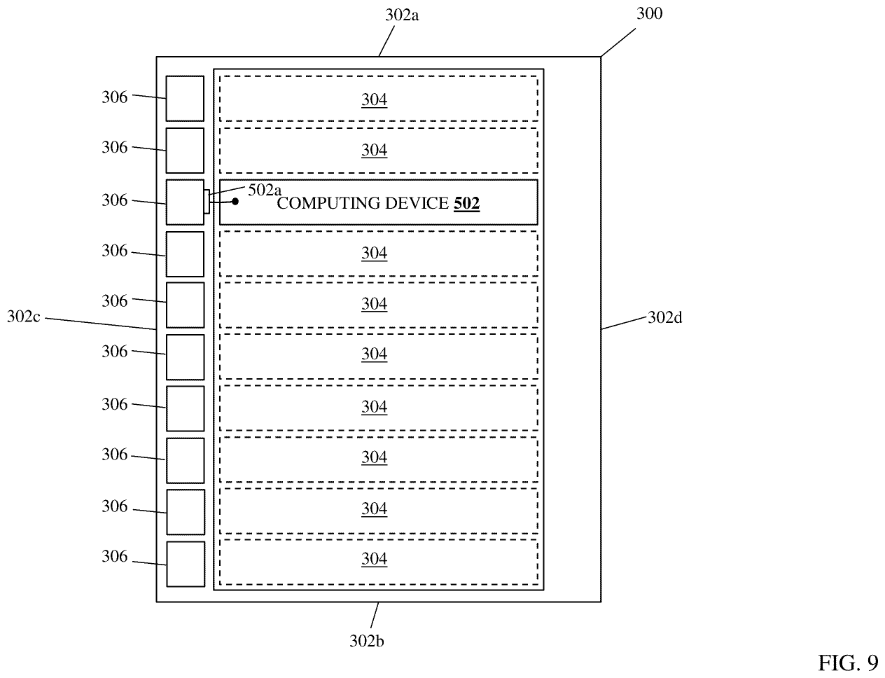

However, one of skill in the art in possession of the present disclosure will appreciate how computing devices may be provided in locations the location-based zero-touch provisioning system of the present disclosure in a variety of manners while remaining within the scope of the present disclosure as well. For example, FIG. 9 illustrates how the computing device 502 discussed above with reference to FIG. 5B may be provided in one of the computing device housings 304 on the rack 300 (i.e., the third computing device housing from the “top” of the rack 300 in the illustrated example), with its NFC tag 502 received by and engaged with the wireless reader subsystem 306 (i.e., an NFC reader subsystem in this example) that is immediately adjacent that computing device housing 304 (i.e., to the left of the computing device housing 304 in which the computing device 502 is located in FIG. 9). While not illustrated or described in detail, one of skill in the art in possession of the present disclosure will appreciate how other computing devices 502 may be provided in any of the computing device housings 304 in the rack 300 and have their NFC tag 502a engaged with the wireless reader subsystem 306 immediately adjacent that computing device housing 304 similarly as described above with reference to FIG. 9.

As discussed above, the tethering of the NFC tag 502a to the chassis 402 of the computing device 502 may allow the NFC tag 502a to move into engagement with the wireless reader subsystem 306 when doing so is necessary to overcome interference issues (e.g., interference issues with other computing devices in the rack 300) and/or other issues (e.g., wireless transmission range limitations) known in the art. As such, in a relatively dense computing device environment like that illustrated in FIG. 9, the engagement of the NFC tag 502a on the computing device 502 with the wireless reader subsystem 306 will ensure that the wireless reader subsystem 306 may read the computing device identification information in the NFC tag 502a on that computing device 502. However, as discussed above and in situations where such interference is not an issue, the wireless reader subsystem 306 may read the NFC tag 502a that is affixed (e.g., adhered) to a surface of the computing device 502 while remaining within the scope of the present disclosure as well.

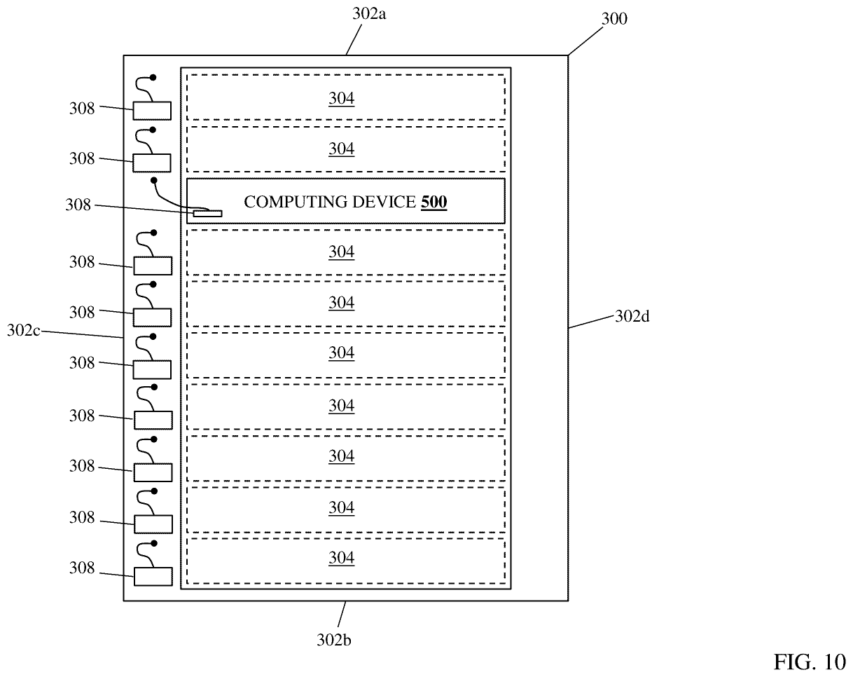

In another example, FIG. 10 illustrates how the computing device 500 discussed above with reference to FIG. 5A may be provided in one of the computing device housings 304 on the rack 300 (i.e., the third computing device housing from the “top” of the rack 300 in the illustrated example), with the wireless tag 308 (i.e., an NFC tag in this example) that is provided immediately adjacent that computing device housing 304 (i.e., to the left of the computing device housing 304 in which the computing device 500 is located in FIG. 10) engaged with the NFC reader device 500a on the computing device 500. While not illustrated or described in detail, one of skill in the art in possession of the present disclosure will appreciate how other computing devices 500 may be provided in any of the computing device housings 304 in the rack 300 and have the wireless tag 308 immediately adjacent that computing device housing 304 engaged with their NFC reader device 500a similarly as described above with reference to FIG. 10.

As discussed above, the tethering of the wireless tags 308 to the rack 300 may allow the wireless tags 308 to move into engagement with computing devices in the rack 300 when doing so is necessary to overcome interference issues (e.g., interference issues with other computing devices in the rack 300) and/or other issues (e.g., wireless transmission range limitations) known in the art. As such, in a relatively dense computing device environment like that illustrated in FIG. 10, the engagement of the wireless tag 308 with the NFC reader device 500a on the computing device 500 will ensure that the NFC reader device 500a may read the location information in the wireless tag 308. However, as discussed above and in situations where such interference is not an issue, the NFC reader device 500a on the computing device 500 may read the wireless tag 308 that is affixed (e.g., adhered) to a surface of the rack 300 while remaining within the scope of the present disclosure as well.

In some embodiments, the location-based zero-touch provisioning operations of the present disclosure may be preceded by a system security verification procedure that operates to verify the locations of the components of the location-based zero-touch provisioning system. For example, each of the wireless tags (e.g., the NFC tags discussed herein) or wireless reader subsystems (e.g., the NFC reader subsystems discussed herein) may be provided (e.g., during its manufacture, during its installation in the location-based zero-touch provisioning system, etc.) with a respective private key included in a respective public/private key pair, and the configuration provisioning system 208/600 may be provided with the public key for each wireless tag or wireless reader subsystems (e.g., stored in a database in association with a wireless tag identifier for that wireless tag, or a wireless reader subsystem identifier for that wireless reader subsystem).

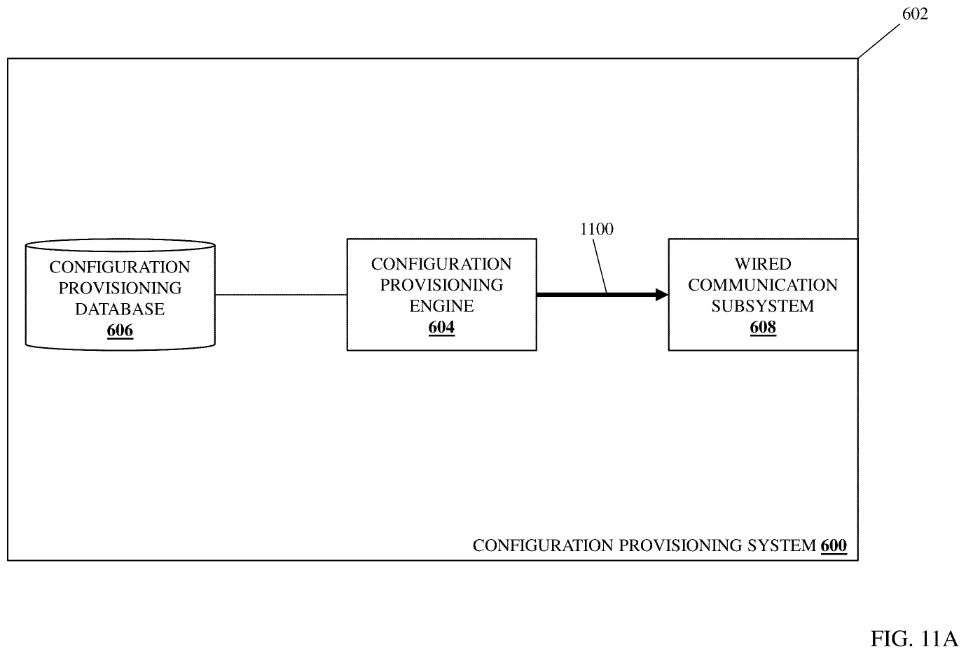

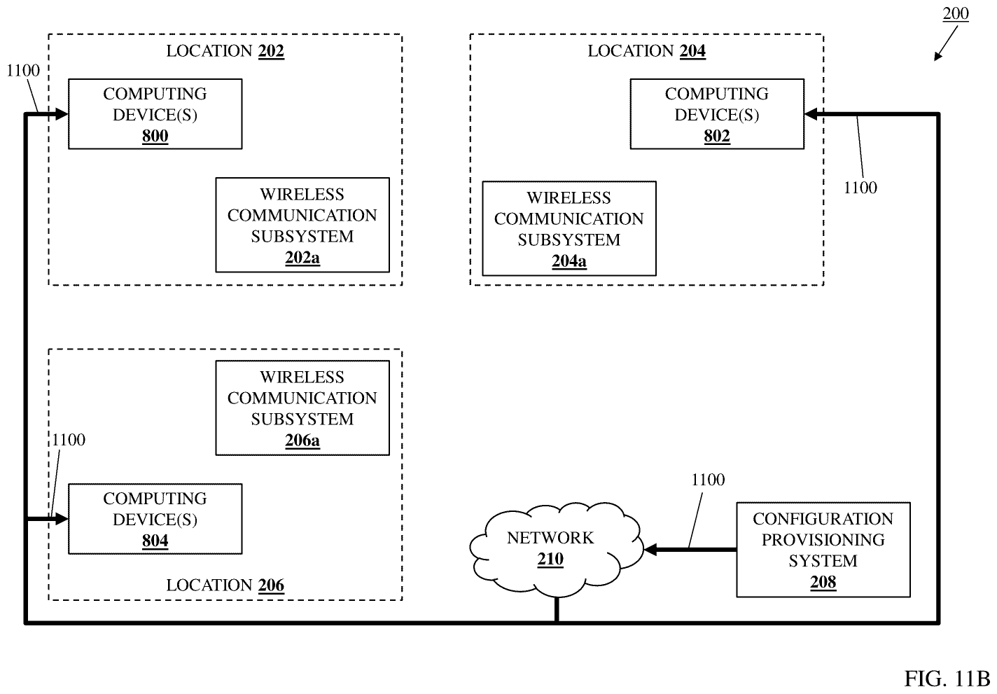

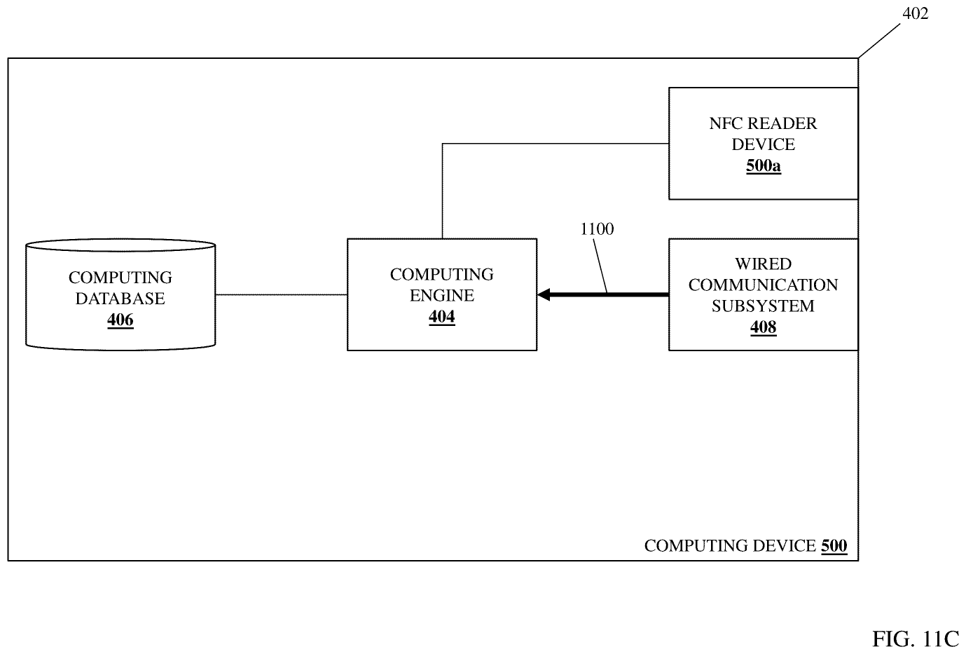

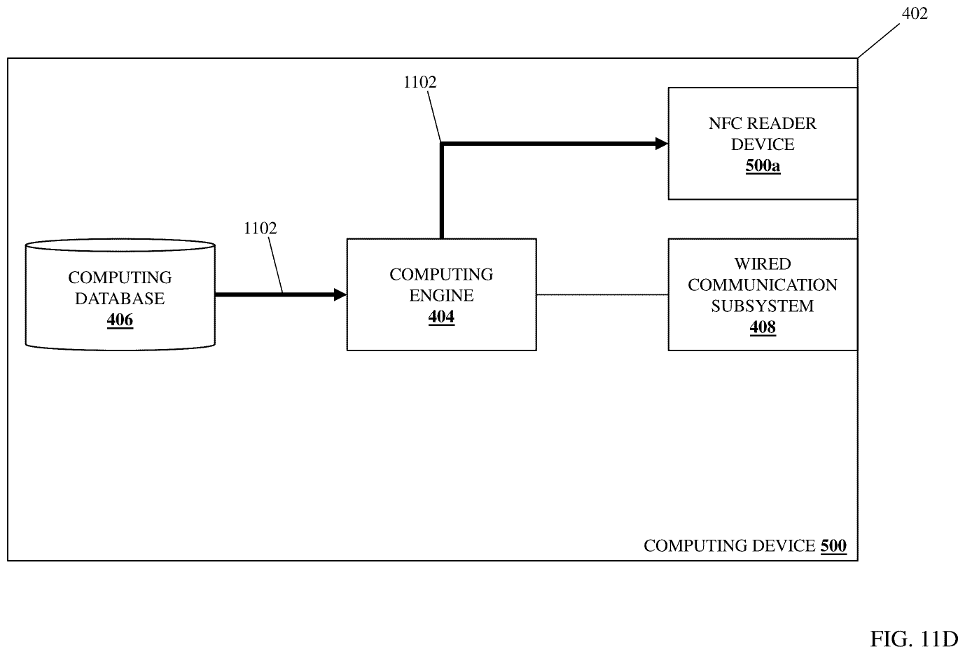

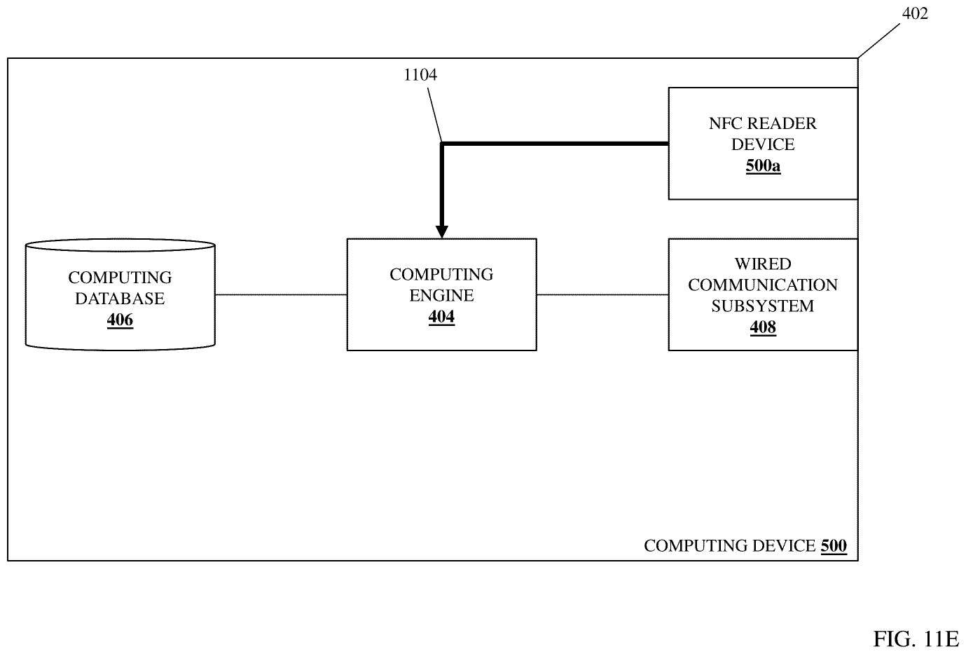

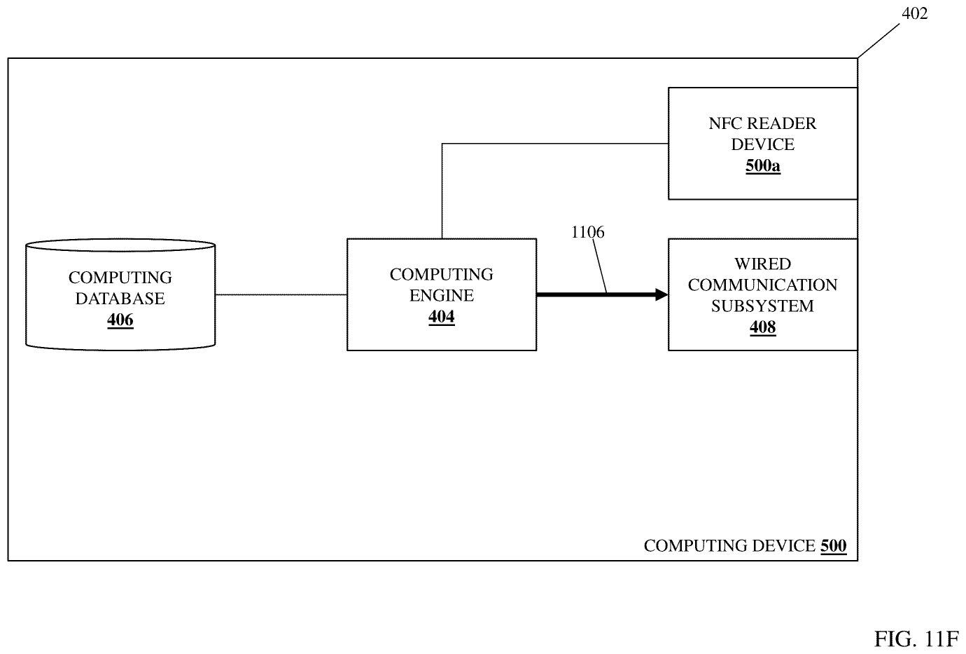

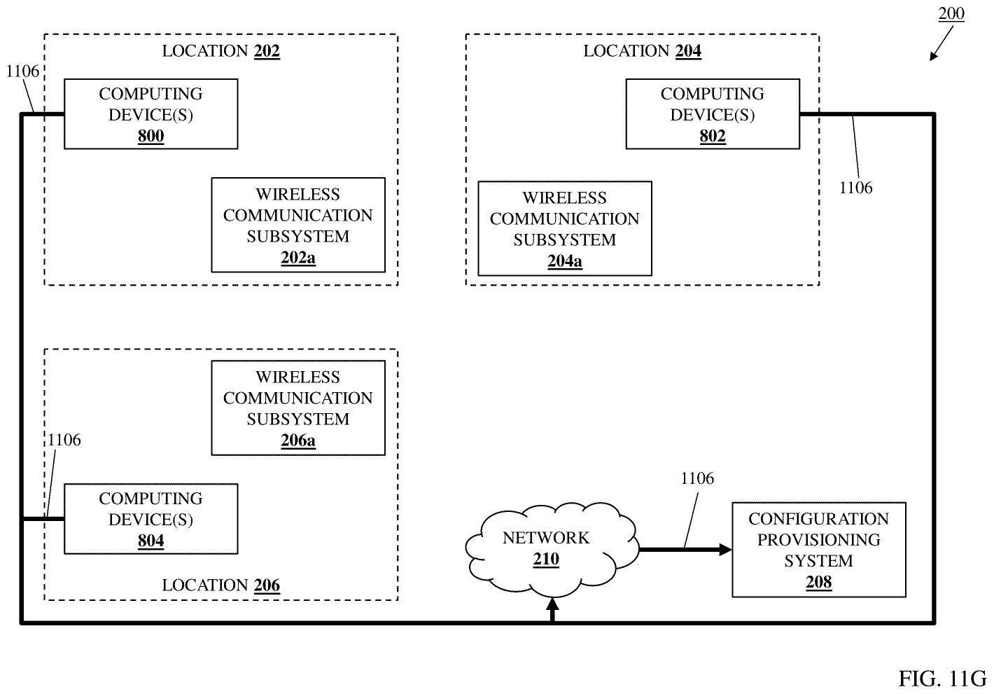

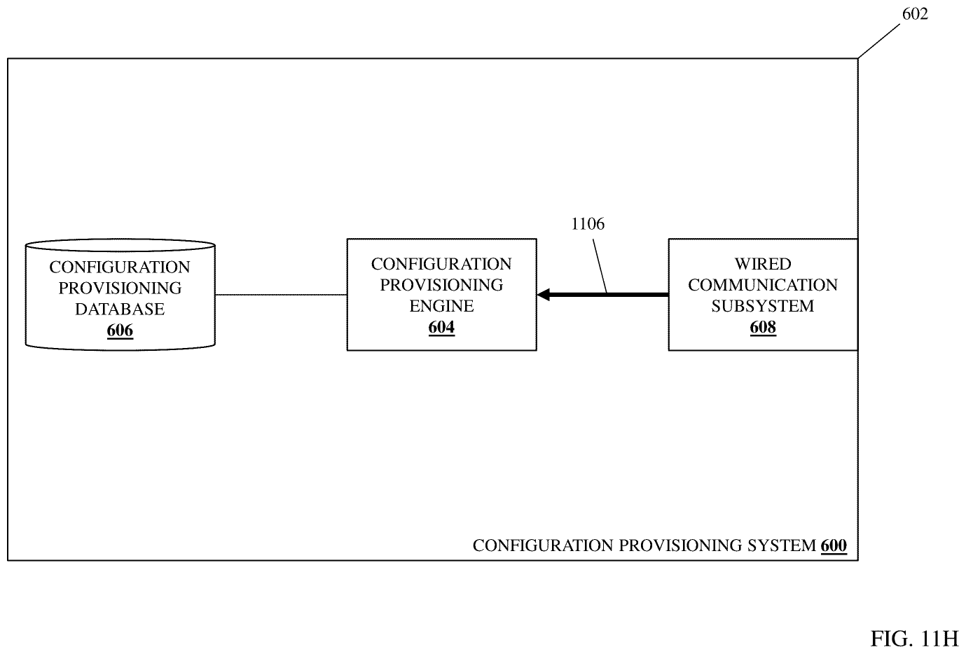

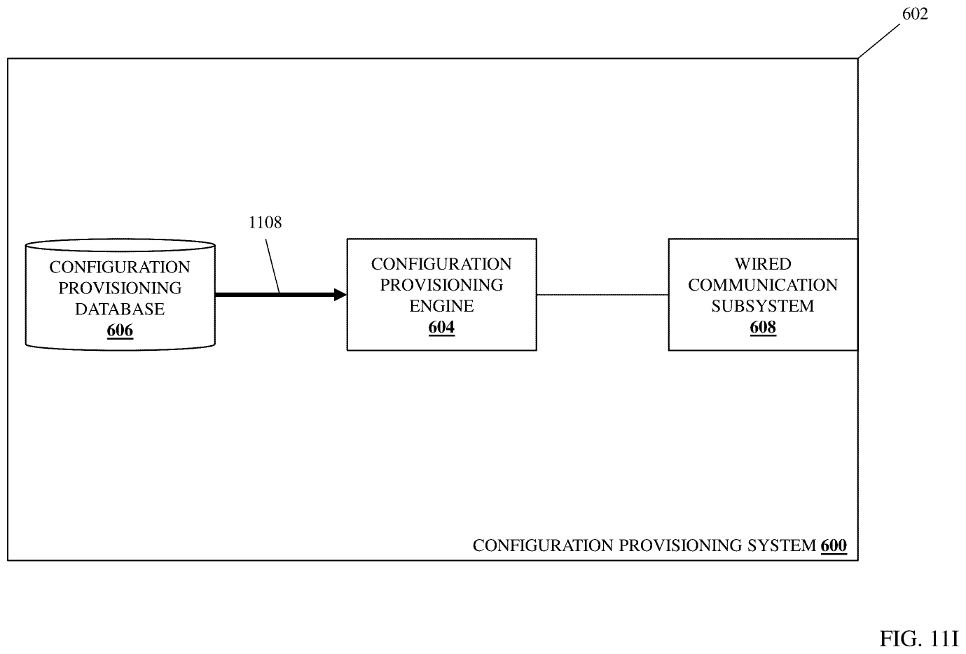

In one example of system security verification procedures, with reference to FIGS. 11A and 11B and in embodiments in which wireless tags provide the wireless communication subsystems 202a, 204a, and 206a at the locations 202, 204, and 206, respectively, the configuration provisioning engine 604 in the configuration provisioning system 208/600 may, for each computing device 800/500, 802/500, and 804/500 provided in the location-based zero-touch provisioning system 200, may perform nonce provisioning operations 1100 that include generating a respective nonce and transmitting that nonce via its wired communication subsystem 608 to the computing engine 404 in that computing device 500 (e.g., via its wired communication subsystem 408 and the wired connection provided via the network 210 discussed above).

Each computing device 500 may then perform concatenated nonce/computing device identifier provisioning operations 1102 that include generating a concatenated nonce/computing device identifier that is a concatenation of the nonce and its computing device identifier (e.g., a serial number of that computing device 500 retrieved from its computing database 406), and wirelessly transmitting (e.g., using its NFC reader device 500a) the concatenated nonce/computing device identifier to the wireless tag that provides the wireless communication subsystem at its location. That wireless tag may then use its private key to encrypt the concatenated nonce/computing device identifier to provide an encrypted concatenated nonce/computing device identifier, and then may wirelessly transmit the encrypted concatenated nonce/computing device identifier along with its wireless tag identifier (e.g., a plaintext version of an identifier for that wireless tag) to the NFC reader device 500a in that computing device 500. As illustrated in FIG. 11E, the NFC reader device 500a in each computing device 500 may then perform encrypted concatenated nonce/computing device identifier and wireless tag identifier provisioning operations 1104 that include transmitting the encrypted concatenated nonce/computing device identifier and wireless tag identifier to the computing engine 404 in its computing device 500.

With reference to FIGS. 11F, 11G, and 11H, each computing device 500 may then perform encrypted concatenated nonce/computing device identifier and wireless tag identifier provisioning operations 1106 that include forwarding the encrypted concatenated nonce/computing device identifier and wireless tag identifier received from the wireless tag at its location to the configuration provisioning system 208/600 (e.g., via their wired communication subsystems 408 and 608 and the wired connection provided by the network 210 as discussed above). With reference to FIG. 11I, the configuration provisioning engine 604 in the configuration provisioning system 208/600 may then perform decryption operations 1108 that include using the wireless tag identifier received from each computing device 500 to identify the public key for a wireless tag (e.g., in its configuration provisioning database 606 in the illustrated embodiment) that is identified as encrypting encrypted concatenated nonce/computing device identifier, and using that public key to decrypt the encrypted concatenated nonce/computing device identifier received from that computing device 500, and one of skill in the art in possession of the present disclosure will appreciate how the decryption of the encrypted concatenated nonce/computing device identifier and the verification of the nonce operates to validate the location of that computing device identified via its computing device identifier (i.e., successful decryption using the public key for the wireless tag and confirmation of the nonce verifies that the computing device having the computing device identifier is using an authorized wireless tag at a location).

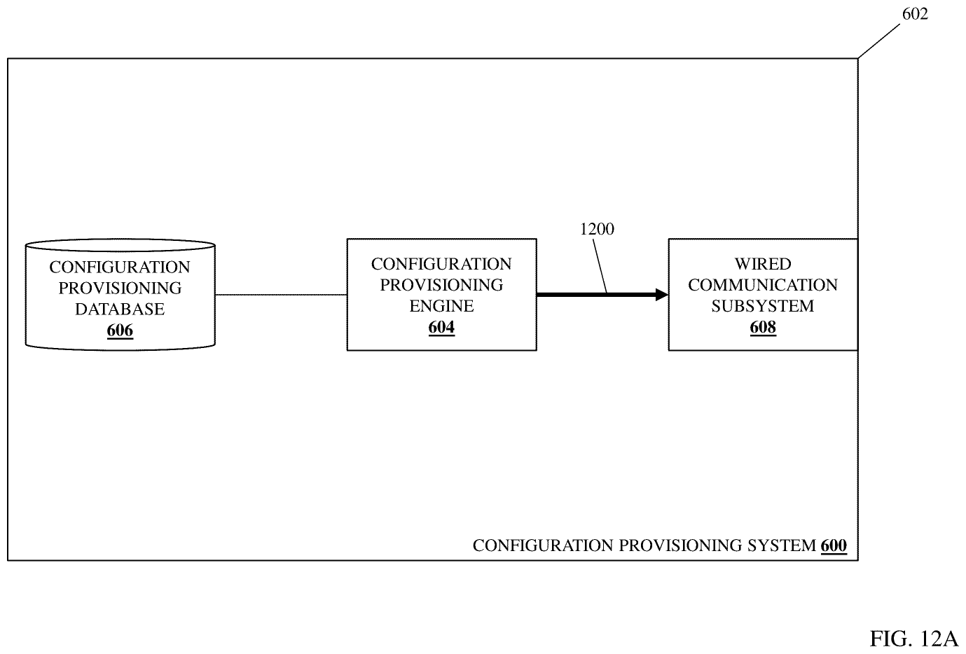

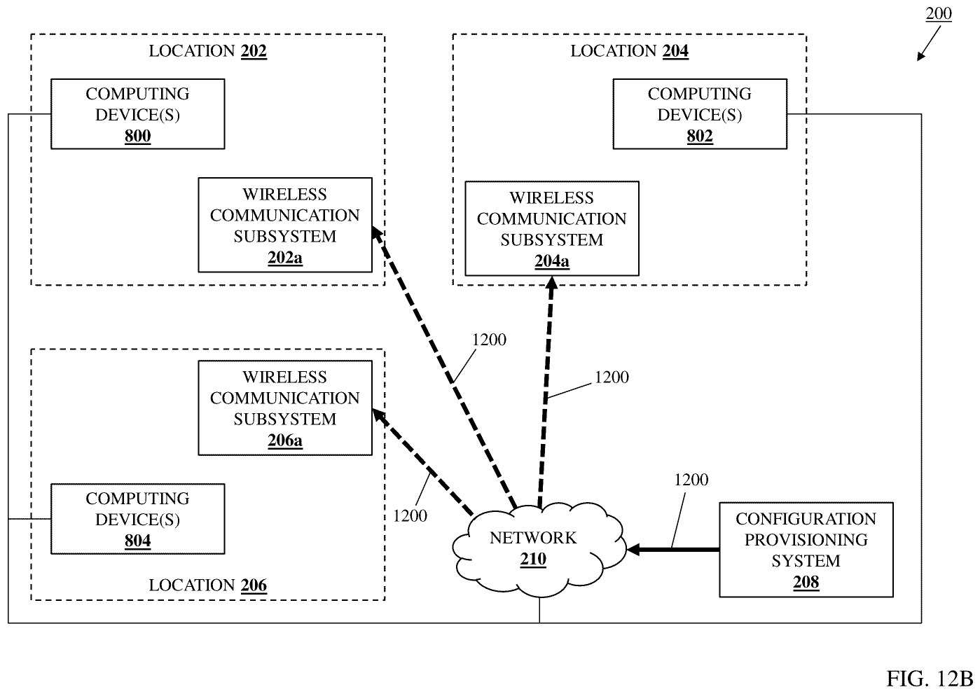

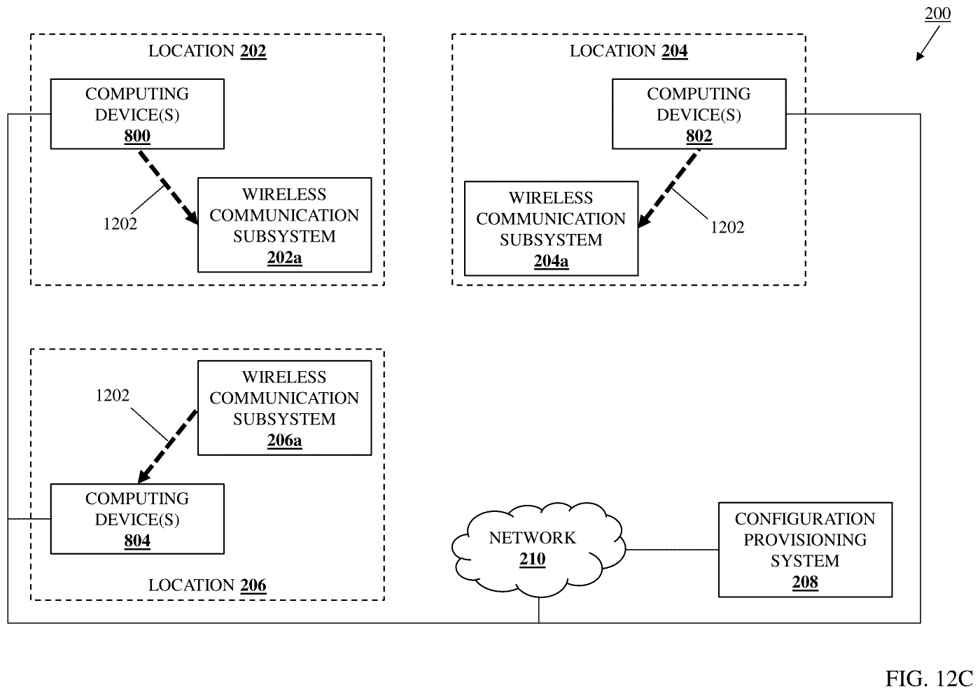

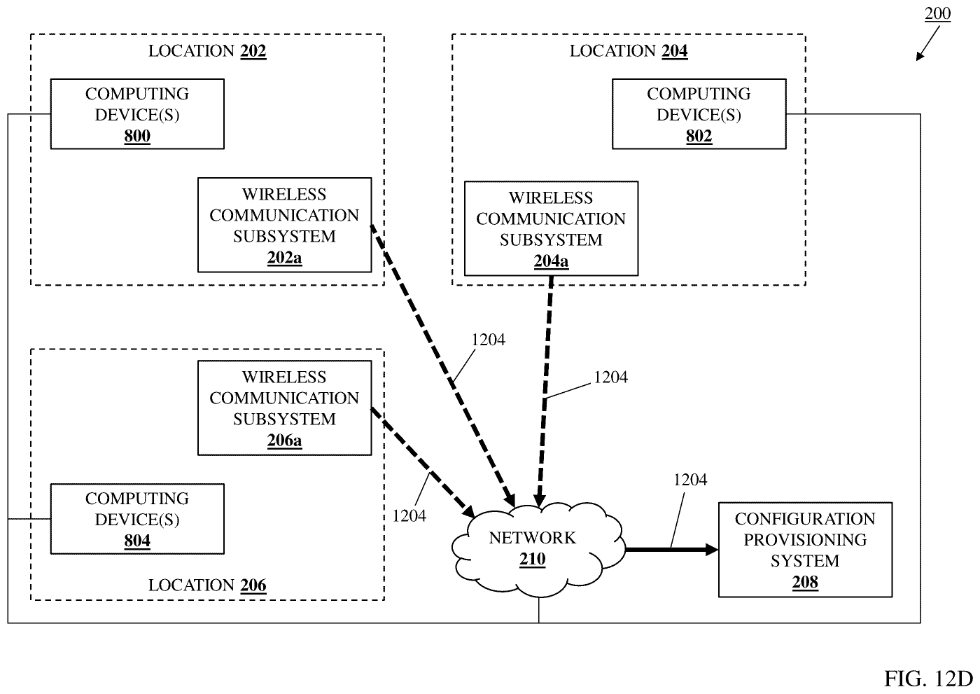

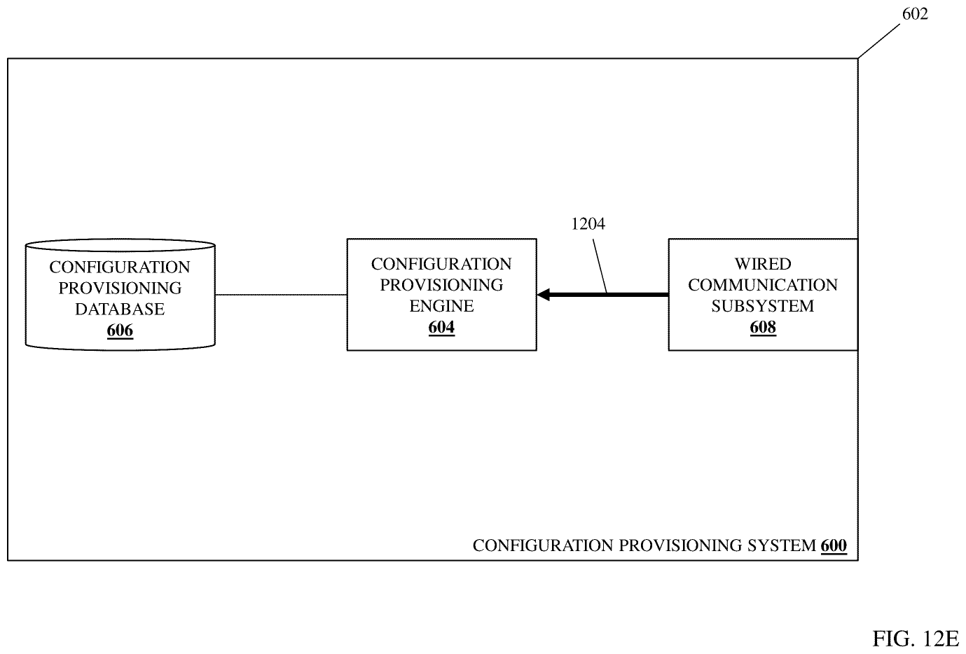

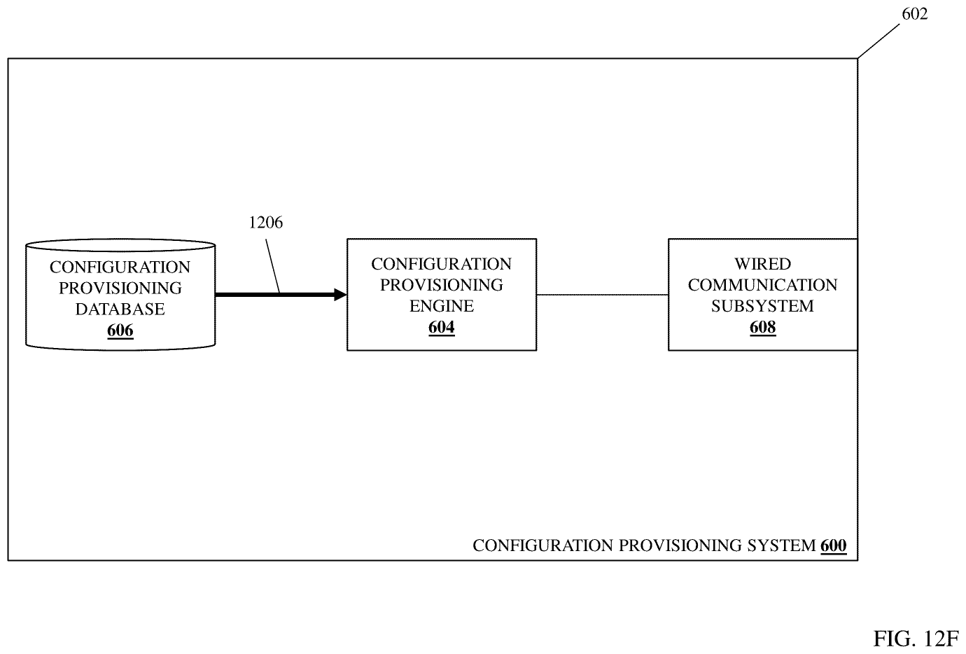

In another example of system security verification procedures, with reference to FIGS. 12A and 12B and in embodiments in which wireless tags provide the wireless communication subsystems on the computing devices 400, the configuration provisioning engine 604 in the configuration provisioning system 208/600 may, for each wireless reader subsystem that provides the wireless communication subsystem 202a, 204a, and 206a in the location-based zero-touch provisioning system 200, perform nonce provisioning operations 1200 that include generating a nonce and wirelessly transmitting (e.g., via its wired communication subsystem 608 and a wireless access point that is included in the network 210 as discussed above) that nonce to that wireless reader subsystem. With reference to FIG. 12C, each wireless reader subsystem at each location may then perform computing device identification information retrieval operations 1202 that include retrieving the computing device identification information from each wireless tag included on a computing device at its location and, for the computing device identification information retrieved from each wireless tag, generate a concatenated nonce/computing device identifier that is a concatenation of the nonce and that computing device identifier, as well as use its private key to encrypt that concatenated nonce/computing device identifier to provide an encrypted concatenated nonce/computing device identifier.

With reference to FIGS. 12D and 12E, each wireless reader subsystem may then perform encrypted concatenated nonce/computing device identifier and wireless reader subsystem identifier provisioning operations 1204 that include wirelessly transmitting its encrypted concatenated nonce/computing device identifier and a wireless reader subsystem identifier (e.g., a plaintext version of an identifier for the wireless reader subsystem) to the configuration provisioning engine 604 in the configuration provisioning system 208/600 (e.g., via the wireless access point in the network 210 discussed above and the wired communication subsystem 608 in the configuration provisioning system 208/600). With reference to FIG. 12F, the configuration provisioning engine 604 in the configuration provisioning system 208/600 may then perform decryption operations 1206 that include using the wireless reader subsystem identifier received from each wireless reader subsystem to identify the public key for that wireless reader subsystem, and using that public key to decrypt the encrypted concatenated nonce/computing device identifier, and one of skill in the art in possession of the present disclosure will appreciate how the decryption of the encrypted concatenated nonce/computing device identifier and the verification of the nonce operates to validate the location of that computing device identified via its computing device identifier (i.e., successful decryption using the public key for the wireless reader subsystem and confirmation of the nonce verifies that the computing device having the computing device identifier is using an authorized wireless reader subsystem at a location).

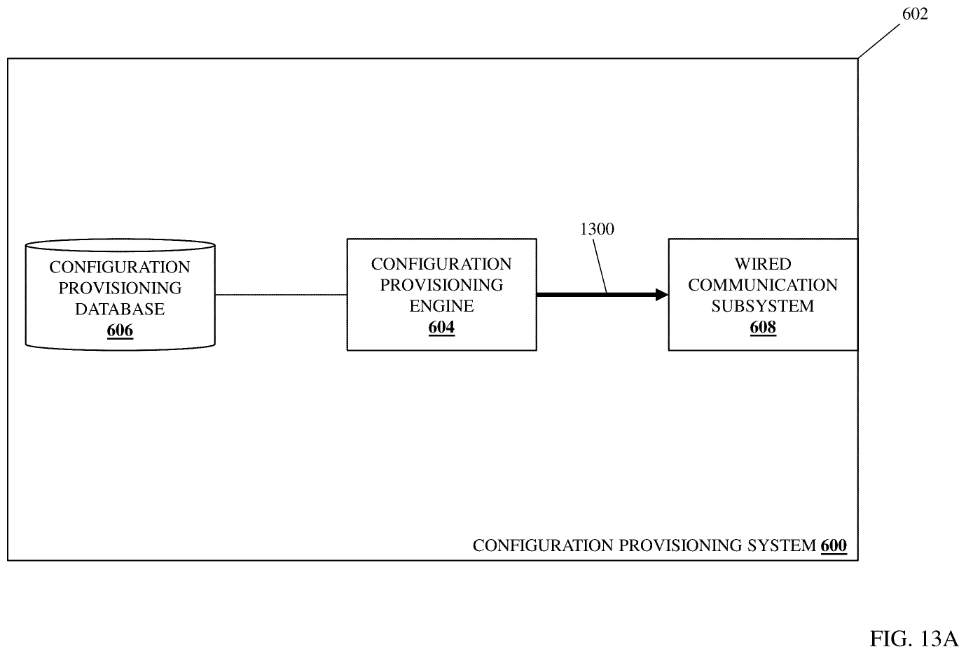

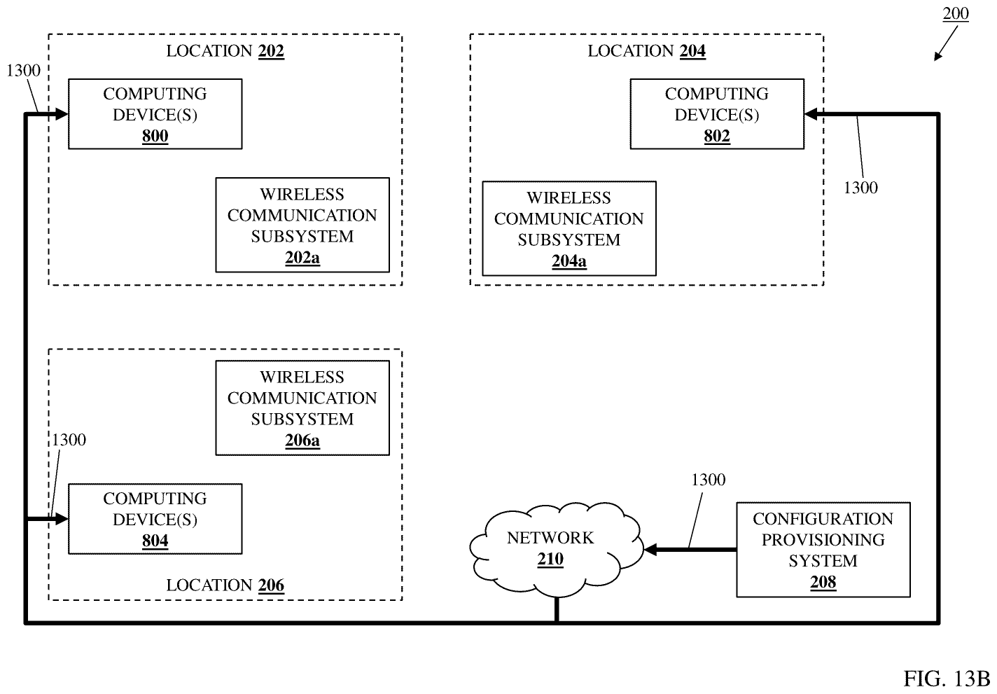

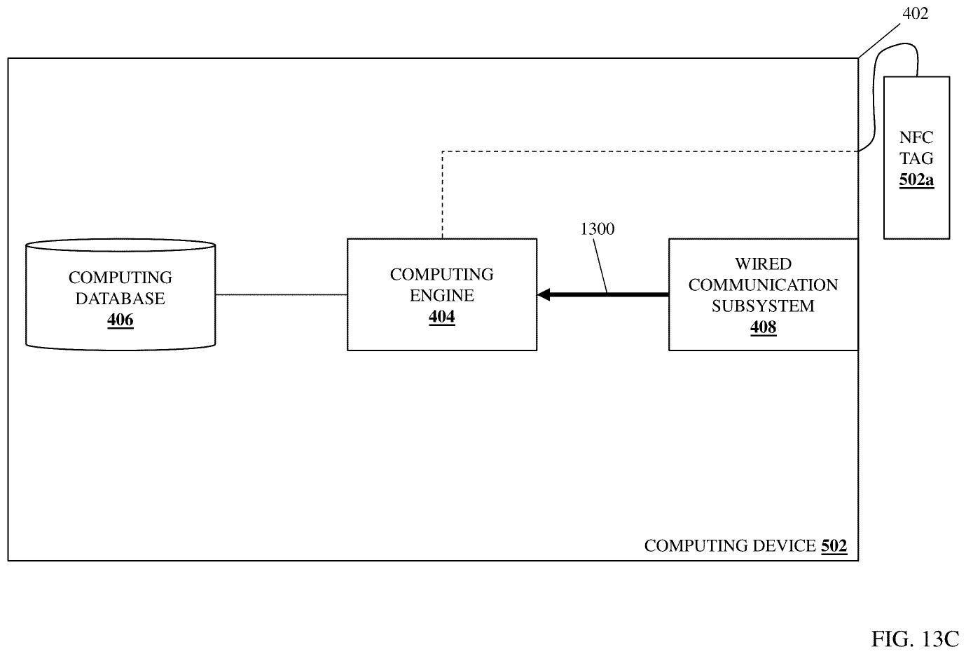

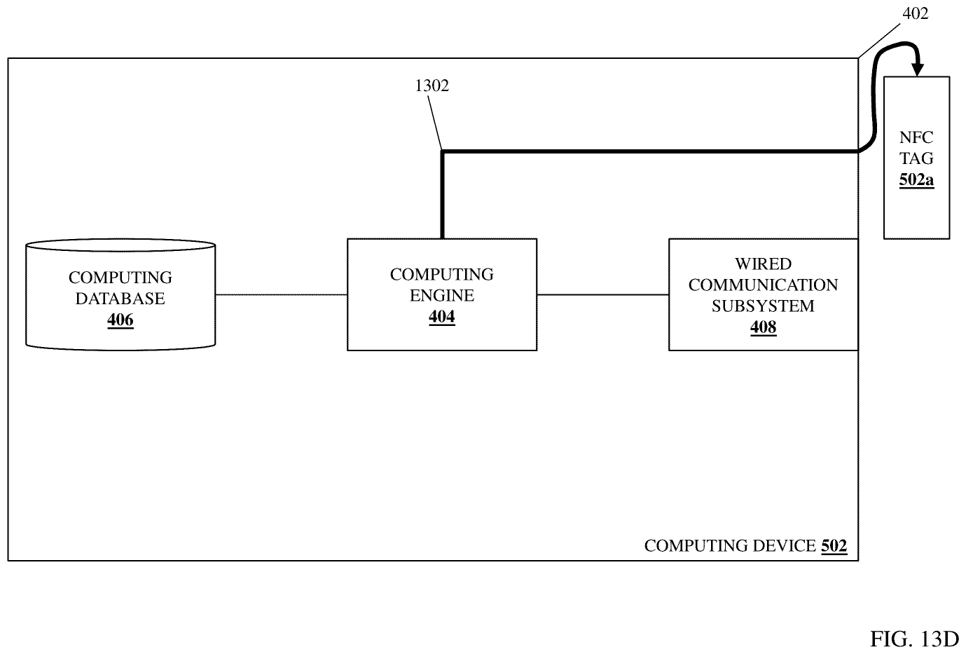

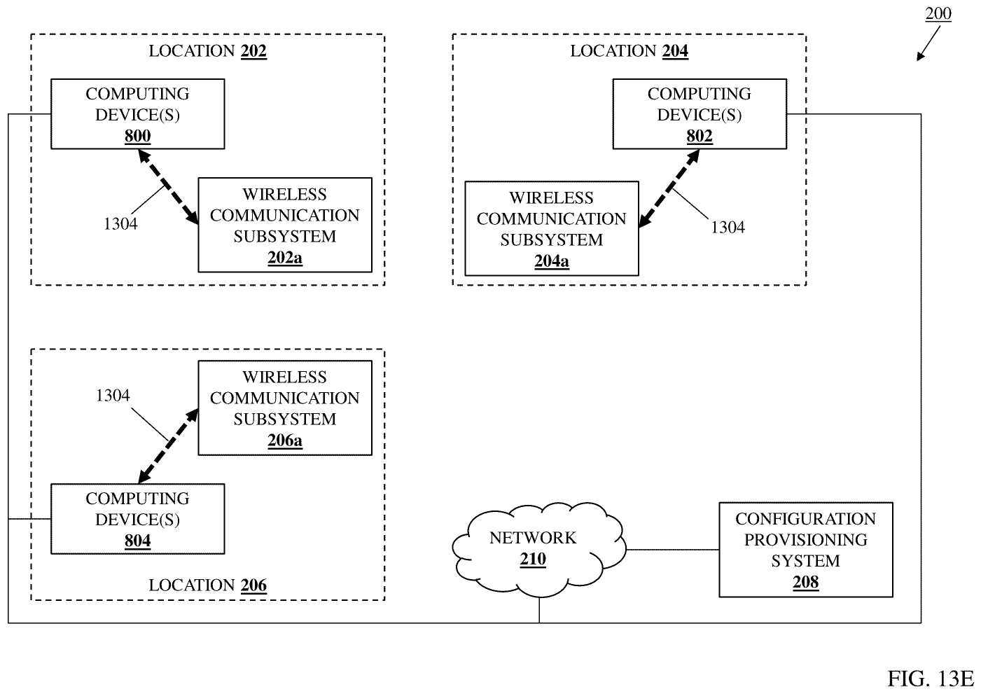

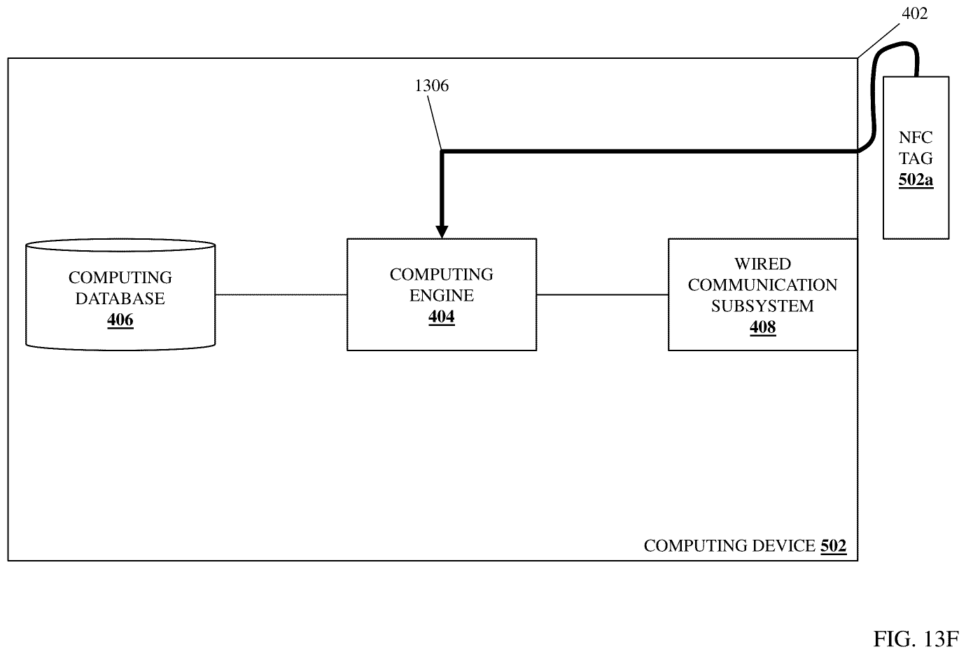

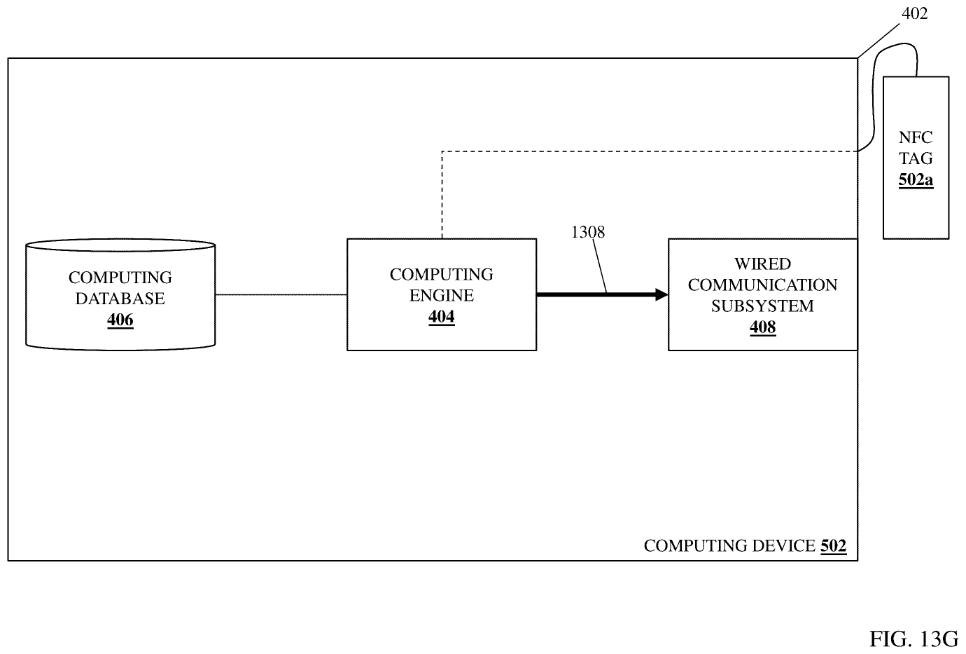

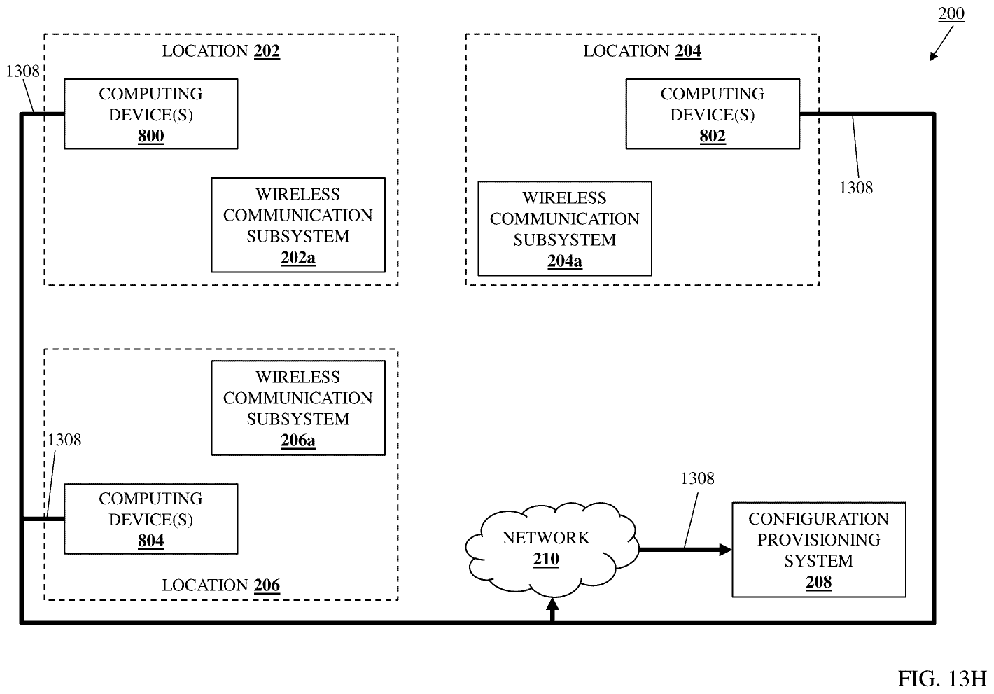

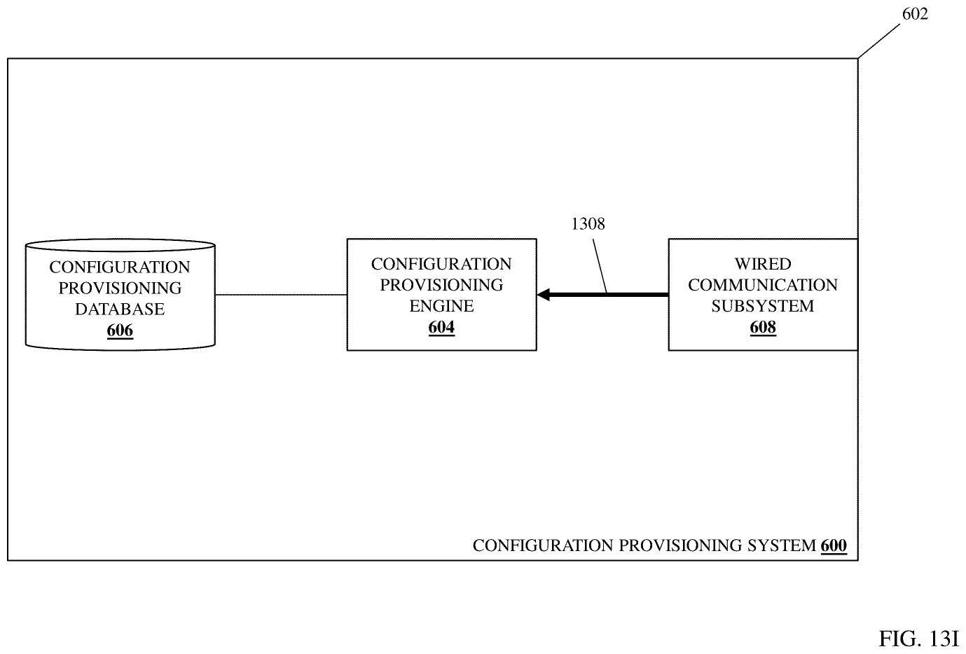

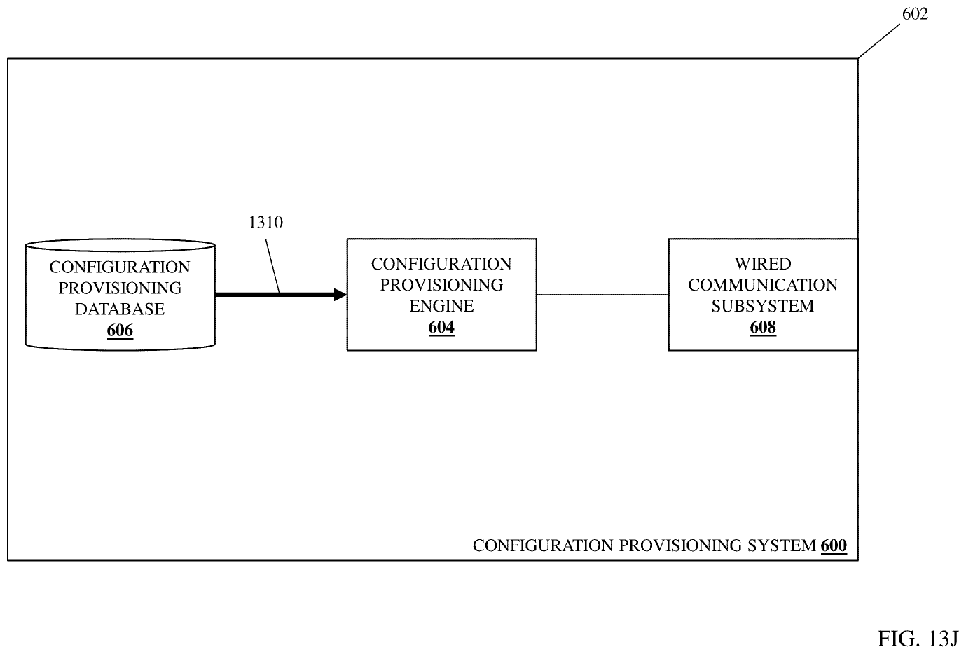

In yet another example of system security verification procedures, with reference to FIGS. 13A, 13B, and 13C and in embodiments in which the QAAT described above provides the wireless communication system 410/NFC tag 502a in the computing device 400/502a, the configuration provisioning engine 604 in the configuration provisioning system 208/600 may, for each computing device 800/502, 802/502, and 804/502 provided in the location-based zero-touch provisioning system 200, perform nonce provisioning operations 1300 that include generating a nonce and transmitting that nonce to the computing engine 404 in that computing device 502 (e.g., via the wired communication subsystems 608 and 408 and the wired connection included in the network 210 as discussed above). With reference to FIG. 13D, the computing engine 404 in each computing device 502 may then perform nonce provisioning operations 1302 that include providing the nonce to the QAAT/NFC tag 502a.

With reference to FIG. 13E, the wireless reader subsystem at each location may then perform encrypted concatenated nonce/computing device identifier and wireless reader subsystem identifier provisioning operations 1304 that include, for each QAAT at its location, reading the nonce and computing device identification information from that QAAT, generating a concatenated nonce/computing device identifier that is a concatenation of the nonce and the computing device identifier, using its private key to encrypt the concatenated nonce/computing device identifier to provide an encrypted concatenated nonce/computing device identifier, and then wirelessly transmitting the encrypted concatenated nonce/computing device identifier along with its wireless reader subsystem identifier (e.g., a plaintext version of an identifier for that wireless reader subsystem) back to that QAAT.

With reference to FIG. 13F, the computing engine 404 in each computing device 502 may then perform encrypted concatenated nonce/computing device identifier and wireless reader subsystem identifier retrieval operations 1306 that include retrieving the encrypted concatenated nonce/computing device identifier and wireless reader subsystem identifier from its QAAT/NFC tag 502a. With reference to FIGS. 13G, 13H, and 13I, the computing engine 404 in each computing device 502 may then perform encrypted concatenated nonce/computing device identifier and wireless reader subsystem identifier provisioning operations 1308 that include transmitting the encrypted concatenated nonce/computing device identifier and wireless reader subsystem identifier to the configuration provisioning system 208/600 (e.g., via the wired communication subsystems 408a and 608 and the wired connection included in the network 210 as discussed above).

With reference to FIG. 13J, the configuration provisioning engine 604 in the configuration provisioning system 208/600 may then perform decryption operations 1310 that include using the wireless reader subsystem identifier to identify the public key for the wireless reader subsystem (e.g., in its configuration provisioning database 606), and using that public key to decrypt the encrypted concatenated nonce/computing device identifier, and one of skill in the art in possession of the present disclosure will appreciate how the decryption of the encrypted concatenated nonce/computing device identifier and the verification of the nonce operates to validate the location of that computing device via its computing device identifier (i.e., successful decryption using the public key for the wireless reader subsystem and confirmation of the nonce verifies that the computing device having the computing device identifier is using an authorized wireless reader subsystem at a location).

In some embodiments, the wireless reader subsystems with which the wireless tags are engaged as described above may periodically confirm the engagement of those wireless tags (e.g., after an initial reading of a wireless tag, the wireless reader subsystem may periodically attempt to read that wireless tag to confirm that is has not been removed or replaced), which will operate to prevent the misuse of the wireless tag with adjacent computing devices. Furthermore, any determination that a wireless tag has been removed or replaced may result in the wireless reader subsystem with which that wireless tag was engaged causing a “wireless tag missing” alert to be generated (e.g., by transmitting a “wireless tag missing” communication to the configuration provisioning system 208/600 to cause the configuration provisioning system 208/600 to generate the “wireless tag missing”alert).

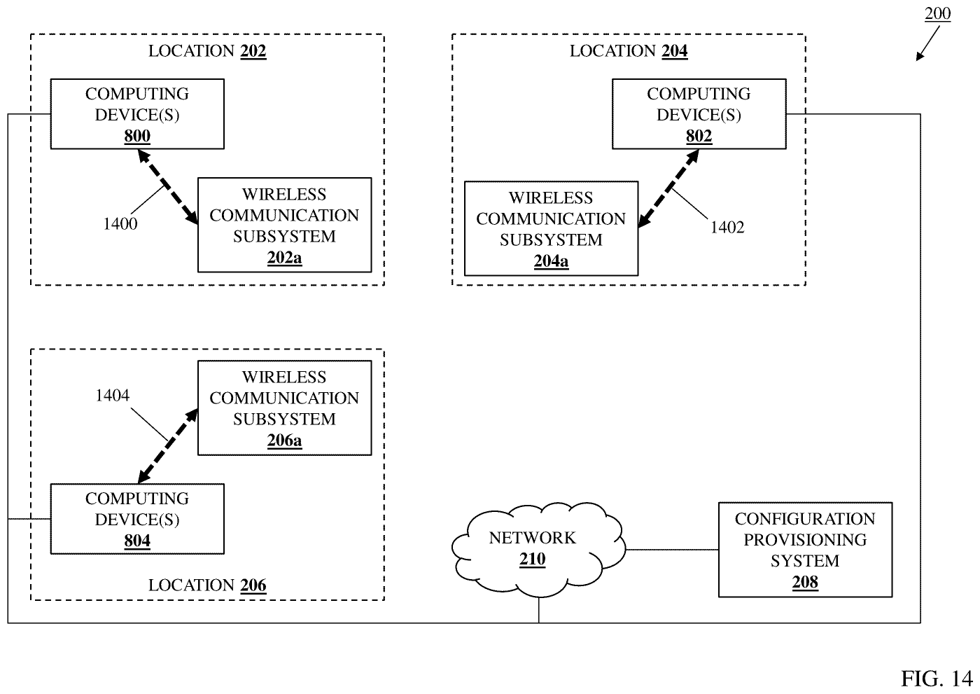

The method 700 then proceeds to block 704 where location information identifying a location of each computing device is provided to a configuration provisioning system in the location-based zero-touch provisioning system. With reference to FIG. 14, in an embodiment of block 704, the computing device(s) 800 and the wireless communication subsystem 202a at the location 202 may perform wireless data exchange operations 1400, the computing device(s) 802 and the wireless communication subsystem 204a at the location 204 may perform wireless data exchange operations 1402, and the computing device(s) 804 and the wireless communication subsystem 206a at the location 206 may perform wireless data exchange operations 1404.

In some examples, the wireless data exchange operations 1400, 1402, and 1404 may include the computing devices 800, 802, and 804 wirelessly transmitting computing device identification information identifying themselves to the wireless communication subsystems 202a, 204a, and 206a, respectively. Continuing with the specific example referenced above, at block 704 each computing device 800/400 in the clothing department that provides the location 202 may use its wireless communication subsystem 410 to wirelessly transmit its computing device identification information (e.g., its base MAC address, service tag, serial number, and/or other computing device identification information known in the art) to the wireless communication subsystem 202a, each computing device 802/400 in the electronics department that provides the location 204 may use its wireless communication subsystem 410 to wirelessly transmit its computing device identification information (e.g., its base MAC address, service tag, serial number, and/or other computing device identification information known in the art) to the wireless communication subsystem 204a, and each computing device 804/400 in the sports department that provides the location 206 may use its wireless communication subsystem 410 to wirelessly transmit its computing device identification information (e.g., its base MAC address, service tag, serial number, and/or other computing device identification information known in the art) to the wireless communication subsystem 206a.

The embodiment discussed above with reference to FIG. 9 provides an example of the wireless data exchange operations discussed above in which computing devices at a location wirelessly transmit computing device identification information identifying themselves to the wireless communication subsystems at that location. As will be appreciated by one of skill in the art in possession of the present disclosure, the engagement of the NFC tag 502a on the computing device 502 with the wireless reader subsystem 306 (i.e., an NFC reader subsystem in this example) on the rack 300 allows the wireless reader subsystem 306 to read the computing device identification information included on that NFC tag 502a.

In other examples, the wireless data exchange operations 1400, 1402, and 1404 may include the wireless communication subsystems 202a, 204a, and 206a wirelessly transmitting location information identifying their locations 202, 204, and 206, respectively, to the computing devices 800, 802, and 804. Continuing with the specific example referenced above, at block 704 the wireless communication subsystem 202a in the clothing department that provides the location 202 may wirelessly transmit location information identifying the location 202 to the wireless communication subsystem 410 in each computing device 800/400, the wireless communication subsystem 204a in the electronics department that provides the location 204 may wirelessly transmit location information identifying the location 204 to the wireless communication subsystem 410 in each computing device 802/400, and the wireless communication subsystem 206a in the sports department that provides the location 206 may wirelessly transmit location information identifying the location 206 to the wireless communication subsystem 410 in each computing device 804/400.

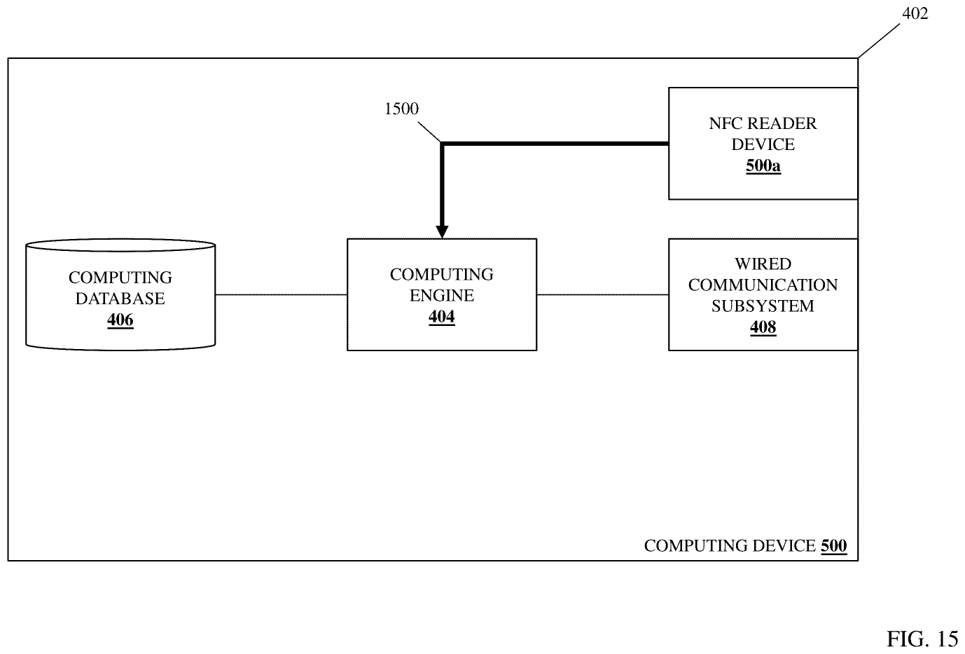

The embodiment discussed above with reference to FIG. 10 provides an example of the wireless data exchange operations discussed above in which wireless communication subsystems at a location wirelessly transmit location information identifying their location to the computing devices at that location. As will be appreciated by one of skill in the art in possession of the present disclosure, the engagement of the wireless tag 308 (i.e., an NFC tag in this example) with the NFC reader device 500a on the computing device 500 allows the NFC reader device 500a to read the location information included on that wireless tag 308, and as illustrated in FIG. 15, the NFC reader device 500a may perform location information transmission operations 1500 to transmit the location information read from the wireless tag 308 to the computing engine 404.

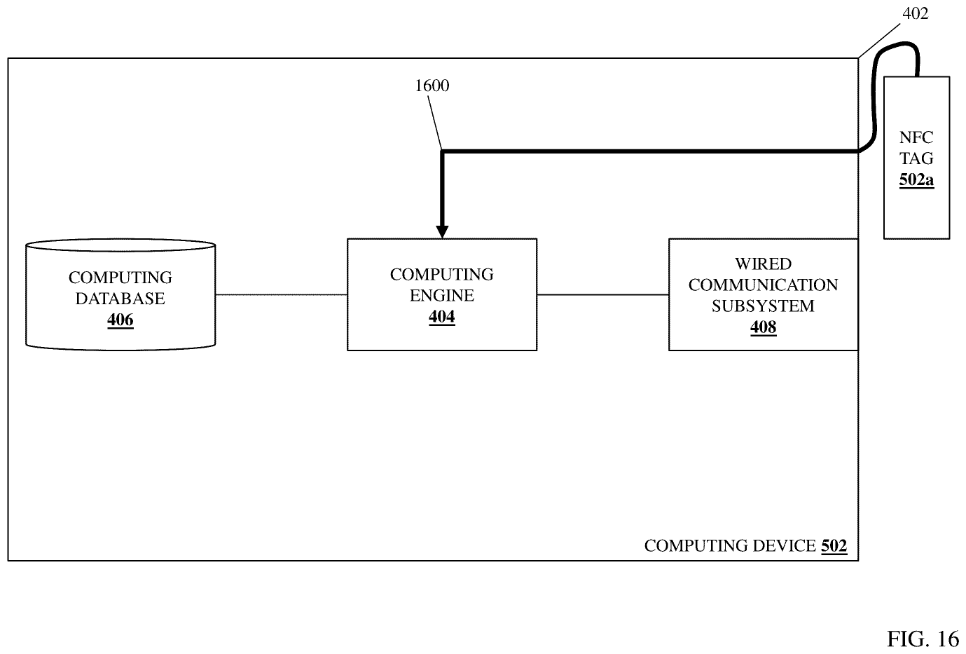

In yet other examples, the wireless data exchange operations 1400, 1402, and 1404 may include the wireless communication subsystems 202a, 204a, and 206a wirelessly providing location information for their location 202, 204, and 206 on the QAATs that provide the NFC tags 502a on the computing devices 800/502, 802/502, and 804/502, respectively, as described above. With reference to FIG. 16, the computing engine 404 in each computing device 502 may then perform location information retrieval operations 1600 that include retrieving the location information from the QAAT that provides its NFC tags 502a.

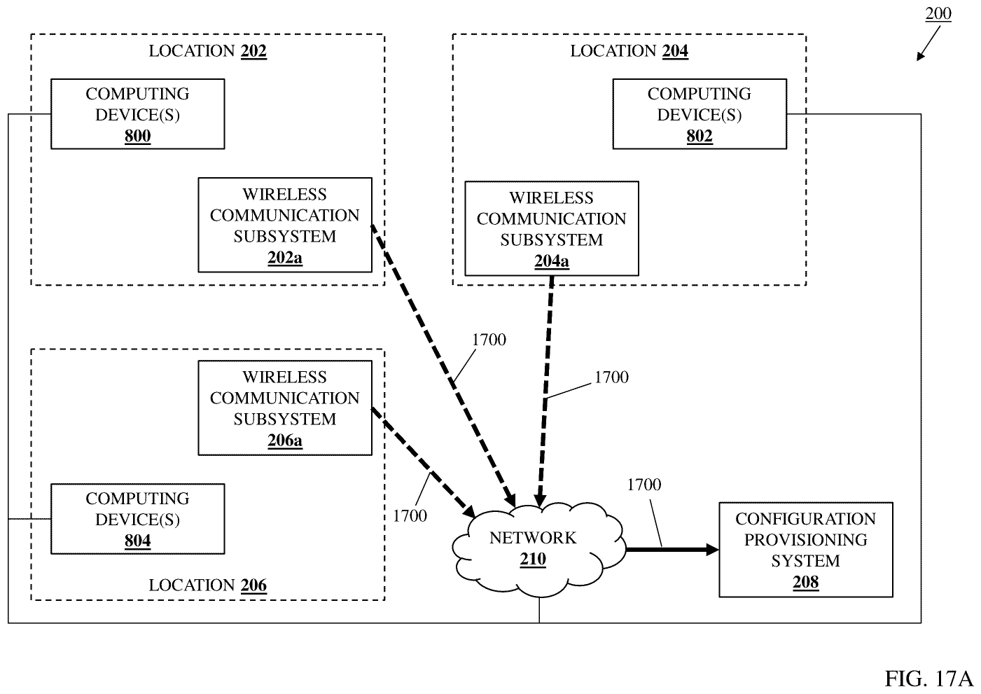

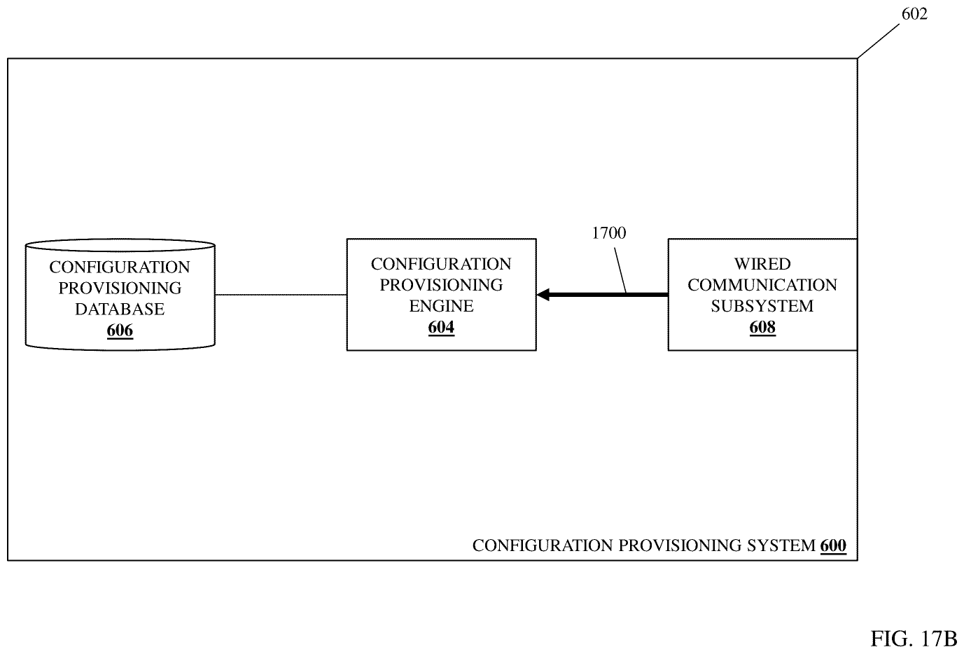

With reference to FIGS. 17A and 17B, in the embodiments of block 704 discussed above in which the wireless communication subsystems 202a, 204a, and 206a at the locations 202, 204, and 206, respectively, received the computing device identification information from their computing devices 800, 802, and 804, respectively, those wireless communication subsystems 202a, 204a, and 206a may perform computing device location information transmission operations 1700 that include wirelessly transmitting location information for their computing devices 800, 802, and 804 to the network 210 (e.g., via a wireless access point included in the network 210 as discussed above) such that it is forwarded to the configuration provisioning system 208/600 and received by the configuration provisioning engine 604 via its wired communication system 608.

For example, in response to receiving the computing device identification information for the computing device(s) 800, the wireless communication subsystem 202a may generate computing device location information communication(s) that include the computing device identification information for each of the computing device(s) 800, location information identifying the location 202, and any other information that one of skill in the art in possession of the present disclosure would recognize as providing for the functionality described below, and wirelessly transmit those computing device location information communication(s) to a wireless access point included in the network 210 such that those computing device location information communication(s) are forwarded to the configuration provisioning system 208.

Similarly, in response to receiving the computing device identification information for the computing device(s) 802, the wireless communication subsystem 204a may generate computing device location information communication(s) that include the computing device identification information for each of the computing device(s) 802, location information identifying the location 204, and any other information that one of skill in the art in possession of the present disclosure would recognize as providing for the functionality described below, and wirelessly transmit those computing device location information communication(s) to a wireless access point included in the network 210 such that those computing device location information communication(s) are forwarded to the configuration provisioning system 208.

Similarly as well, in response to receiving the computing device identification information for the computing device(s) 802, the wireless communication subsystem 206a may generate computing device location information communication(s) that include the computing device identification information for each of the computing device(s) 804, location information identifying the location 206, and any other information that one of skill in the art in possession of the present disclosure would recognize as providing for the functionality described below, and wirelessly transmit those computing device location information communication(s) to a wireless access point included in the network 210 such that those computing device location information communication(s) are forwarded to the configuration provisioning system 208.

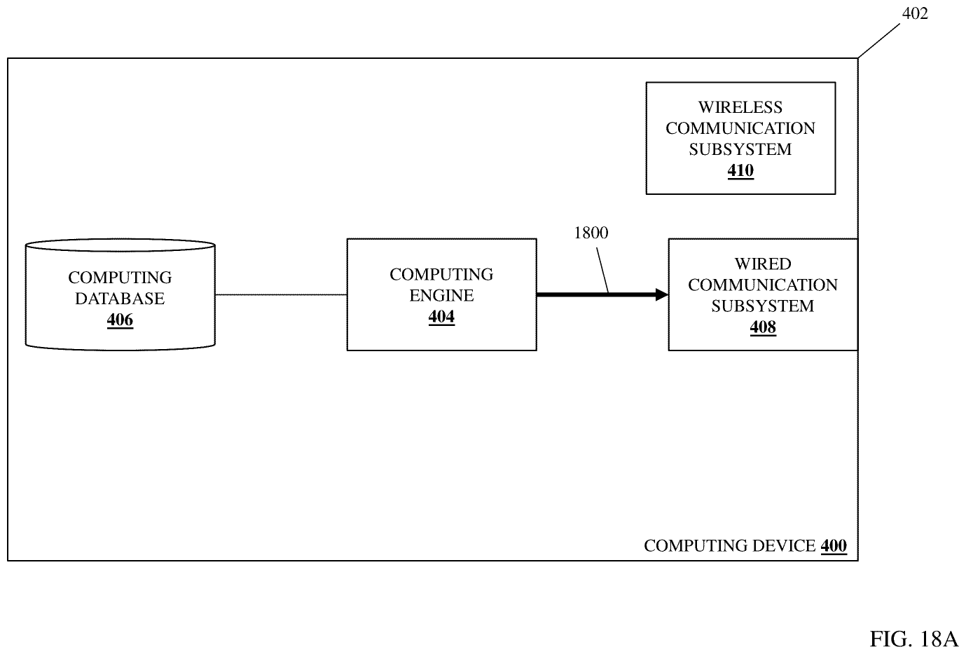

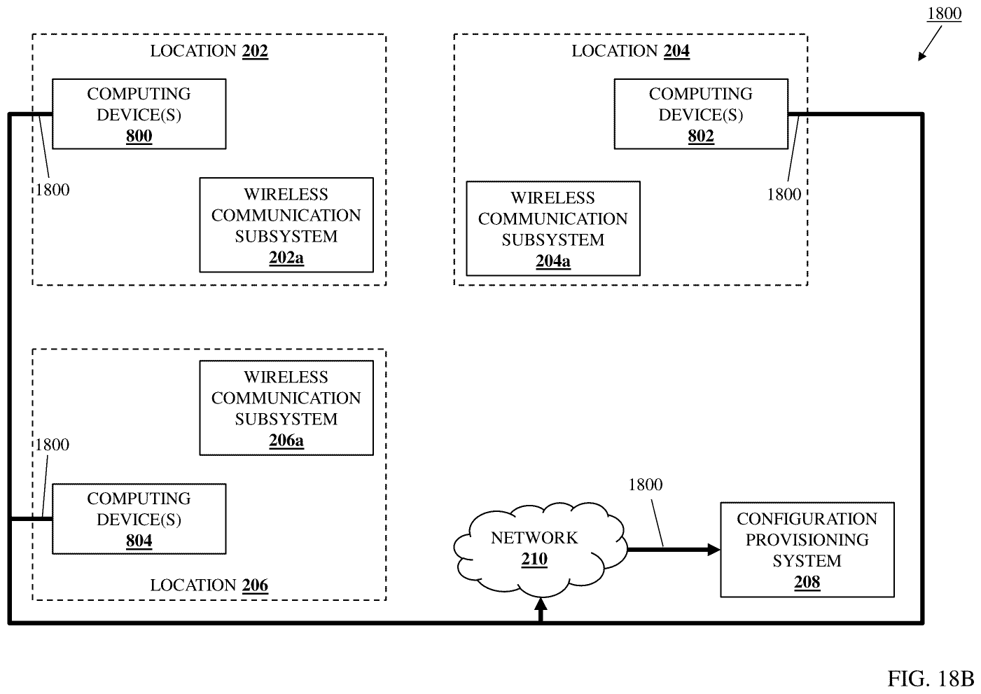

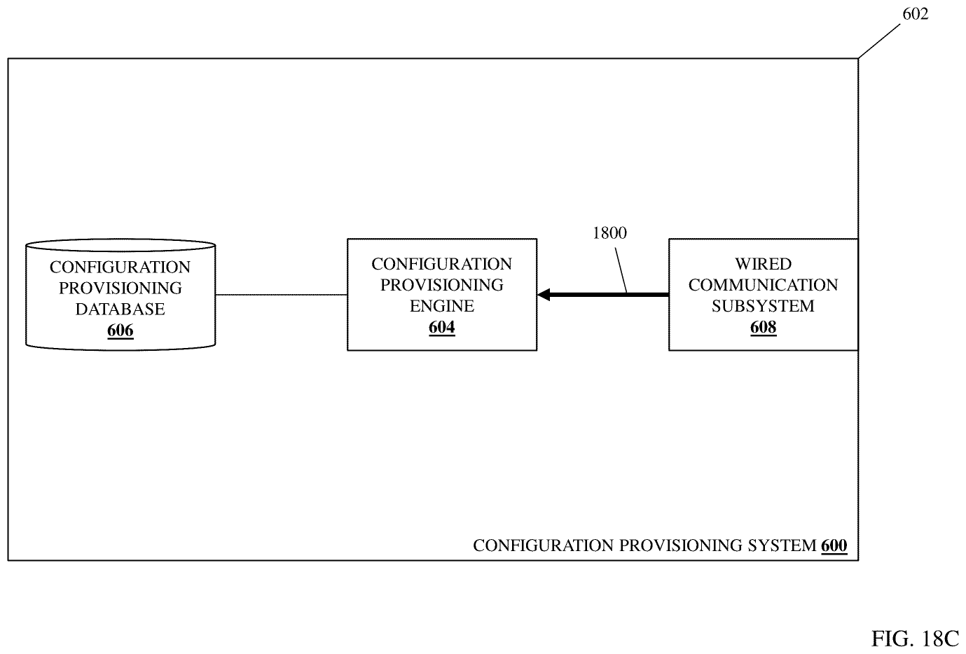

With reference to FIGS. 18A, 18B, and 18C, in the embodiments of block 704 discussed above in which the computing engine 404 in the computing devices 800, 802, and 804 at the locations 202, 204, and 206, respectively, received the location information from the wireless communication subsystems 202a, 204a, and 206a, respectively (i.e., from wireless tags provided at the locations, or from wireless reader subsystems at the locations via their QAATs/NFC tags 502a), the computing engines 404 in those computing devices 800/400, 802/400, and 804/400 may perform computing device location information transmission operations 1800 that include transmitting their received location information via their wired communication subsystems 408 and through the network 210 such that they are received by the configuration provisioning engine 604 in the configuration provisioning system 208/600.

For example, in response to receiving the location information identifying the location 202 from the wireless communication subsystem 202a, the computing engine 404 in each computing device 800/400 may generate computing device location information communication(s) that include the computing device identification information for that computing device 800/400 (e.g., its base MAC address, service tag, serial number, and/or other computing device identification information known in the art), the location information identifying the location 202, and any other information that one of skill in the art in possession of the present disclosure would recognize as providing for the functionality described below, and transmit the computing device location information communication(s) via its wired communication subsystem 408 and through the network 210 to the configuration provisioning system 208.

Similarly, in response to receiving the location information identifying the location 204 from the wireless communication subsystem 204a, the computing engine 404 in each computing device 802/400 may generate computing device location information communication(s) that include the computing device identification information for that computing device 802/400 (e.g., its base MAC address, service tag, serial number, and/or other computing device identification information known in the art), the location information identifying the location 204, and any other information that one of skill in the art in possession of the present disclosure would recognize as providing for the functionality described below, and transmit the computing device location information communication(s) via its wired communication subsystem 408 and through the network 210 to the configuration provisioning system 208.

Similarly as well, in response to receiving the location information identifying the location 206 from the wireless communication subsystem 206a, the computing engine 404 in each computing device 804/400 may generate computing device location information communication(s) that include the computing device identification information for that computing device 804/400 (e.g., its base MAC address, service tag, serial number, and/or other computing device identification information known in the art), the location information identifying the location 206, and any other information that one of skill in the art in possession of the present disclosure would recognize as providing for the functionality described below, and transmit the computing device location information communication(s) via its wired communication subsystem 408 and through the network 210 to the configuration provisioning system 208.

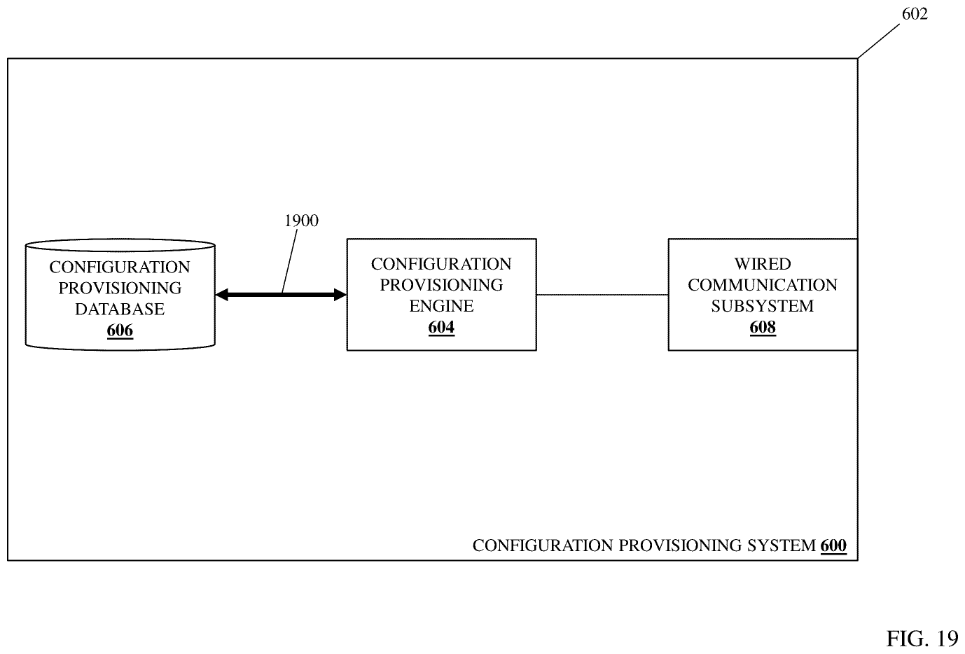

The method 700 then proceeds to block 706 where the configuration provisioning system identifies a configuration mapped to a location of a computing device. With reference to FIG. 19, in an embodiment of block 706 and in response to receiving the location information identifying a location of each computing device in the location-based zero-touch provisioning system, the configuration provisioning engine 604 may perform configuration identification operations 1900 that may include accessing a location/configuration mapping in the configuration provisioning database 606 and using the location(s) identified by the location information to identify device configurations for device(s) in those location(s).

For example, with reference to the location/configuration mapping 606a discussed above with reference to FIG. 6B, location information identifying the location 202 corresponds to the top row in the location/configuration mapping 606a (i.e., based on the location identifier “202” for the “CLOTHING DEPARTMENT”) and results in the identification of a first device configuration (i.e., based on the “DEVICE CONFIGURATION IDENTIFIER 1”), location information identifying the location 204 corresponds to the middle row in the location/configuration mapping 606a (i.e., based on the location identifier “204” for the “ELECTRONICS DEPARTMENT”) and results in the identification of a second device configuration (i.e., based on the “DEVICE CONFIGURATION IDENTIFIER 2”), and location information identifying the location 206 corresponds to the bottom row in the location/configuration mapping 606a (i.e., based on the location identifier “206” for the “SPORTS DEPARTMENT”) and results in the identification of a third device configuration (i.e., based on the “DEVICE CONFIGURATION IDENTIFIER 3”).

Similarly, with reference to FIG. 9 or 10, location information identifying the rack 300 may be used to identify a configuration for the computing device 500 or 502 (as well as any other computing devices in the rack 300) based on a location/configuration mapping that maps the rack 300 to that configuration (e.g., the rack 300 may be configured to house only spine switch devices, and thus the rack 300 may be mapped to a spine switch device configuration). Similarly as well, with reference to FIG. 9 or 10, location information identifying the computing device housing 304 in the rack 300 in which the computing device 500 or 502 is located may be used to identify a configuration for the computing device 500 or 502 based on a location/configuration mapping that maps that computing device housing 304 in the rack 300 to that configuration (e.g., the computing device housing 304 in the rack 300 in which the computing device 500 or 502 is located may be configured to house only Top Of Rack (TOR) switch devices, and thus the computing device housing 304 in the rack 300 in which the computing device 500 or 502 is located may be mapped to a TOR switch device configuration). As such, one of skill in the art in possession of the present disclosure will appreciate how different subsets of computing device housings in a rack may provide locations in the location-based zero-touch provisioning system that are mapped to different device configurations.

As will be appreciated by one of skill in the art in possession of the present disclosure, the identification of configurations for computing devices based on the locations of those computing devices allows a network administrator or other user to perform a single location-based configuration set up of the location-based zero-touch provisioning system that includes configuring the configuration provisioning system 208/600 with the location/configuration mapping that identifies the configurations for computing devices at each location in the location-based zero-touch provisioning system, and either configuring each of the wireless reader subsystems provided at those locations with the identity of their location, or configuring each of the wireless tags provided at those locations with the identity of their location. Subsequent to such configurations, any computing device provided at one of those locations may have its configuration identified (and “zero-touch provisioned” as described below) based on that location and without the need to map the identity of that computing device (i.e., the base MAC address, service tag, serial number, or other computing device identification information of that computing device) to that configuration in the configuration provisioning system 208/600.

The method 700 may then proceed to optional decision block 708 where it is determined whether one or more capabilities of the computing device support the configuration identified as mapped to the location of that computing device. In an embodiment, at optional decision block 708, the configuration provisioning engine 604 in the configuration provisioning system 600 may identify one or more capabilities of each of the computing devices for which a configuration was identified (i.e., based on the location of that computing device), and determine whether those capabilit(ies) support that configuration. For example, for any particular computing device for which a configuration was identified at block 706, the configuration provisioning engine 604 may use the computing device identification information (i.e., the base MAC address, service tag, serial number, or other computing device identification information of that computing device) to identify one or more capabilities of that computing device, and then verify whether those capabilit(ies) support the configuration that was identified for that computing device at block 706.

To provide a specific example, the configuration provisioning engine 604 may access a database (e.g., a publicly available database via the Internet) and use the computing device identification information (e.g., a make/model of the computing device included in or associated with the computing device identification information) of a computing device to identify a number of ports included on that computing device, and then verify whether that number of ports satisfies the requirements of the configuration that was identified for that computing device based its location at block 706. However, while a specific example has been provided, one of skill in the art in possession of the present disclosure will appreciate how the configuration provisioning system 208/600 may identify capabilities of a computing device in a variety of manners (and particularly in a manner that does not require the identity of that computing device to be manually mapped to those capabilities by a network administrator or user of the location-based zero-touch provisioning system), and then compare those capabilities to configurations identified at block 706 while remaining within the scope of the present disclosure.

If, at optional decision block 708, it is determined that one or more capabilities of the computing device do not support the configuration identified as mapped to the location of that computing device, the method 700 may proceed to optional block 710 where the configuration provisioning system provides a capability/configuration alert. In an embodiment, at optional block 710 and in response to determining that the capabilit(ies) of a computing device do not support the configuration that was identified for that computing device, the configuration provisioning engine 604 in the computing provisioning system 208/600 may generate a capability/configuration alert that describes the failure of the computing device to support the configuration identified for it (e.g., “computing device does not include sufficient ports to support the configuration identified for it based on its current location”), and provide that capability/configuration alert for display (e.g., on a display device that is coupled to the configuration provisioning engine 604 or accessible to the configuration provisioning engine 604 via a network). However, while a specific example has been provided, one of skill in the art in possession of the present disclosure will appreciate how the configuration provisioning system 208/600 may perform other operations that will fall within the scope of the present disclosure in response to determining that the capabilit(ies) of a computing device do not support the configuration that was identified for that computing device.

Following optional block 710, the method 700 returns to block 706. As such, in embodiments that include optional decision block 708 and optional block 710, the method 700 may loop such that the configuration provisioning system 208/600 generates and provides capability/configuration alerts for any computing device that does not have capabilities to support the configuration identified for that computing device based on its location. As such, a network administrator or other user may be informed if a computing device is provided at a location that requires a configuration that computing device does not support (e.g., a server device is provided in a computing device housing 304 in the rack 300 of FIG. 3A or 3B that is meant for a switch device), and may replace that computing device with a computing device that supports that configuration.

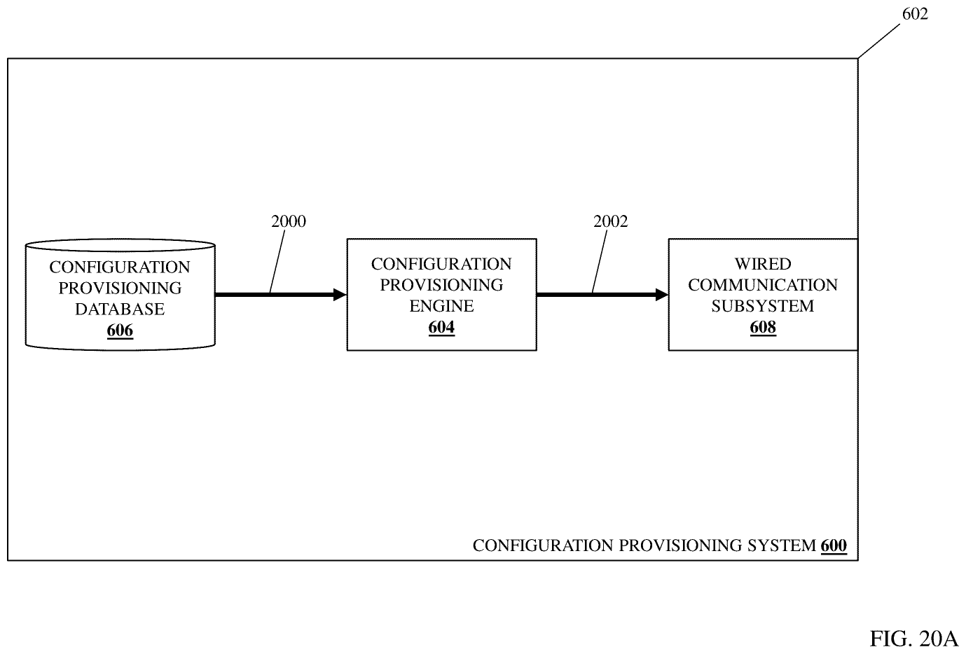

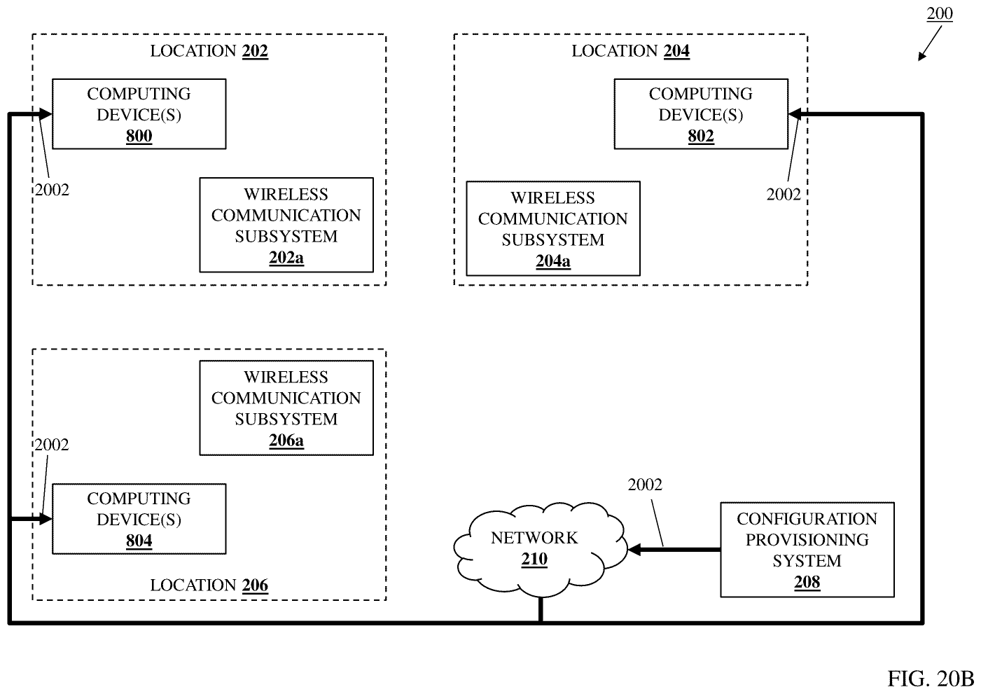

If, at optional decision block 708, it is determined that the capabilities of the computing device support the configuration identified as mapped to the location of that computing device, or in embodiments in which optional decision block 708 is not performed, the method 700 proceeds to block 712 where the configuration provisioning system provides the configuration to the computing device to configure the computing device with the configuration. With reference to FIGS. 20A and 20B, in an embodiment of block 712, the configuration provisioning engine 604 in the configuration provisioning system 208/600 may perform configuration retrieval operations 2000 that include retrieving the configuration identified for each of the computing devices 800, 802, and 804 at block 706 (e.g., from the configuration provisioning database 606 and/or other configuration database that is accessible to the configuration provisioning engine 604). The configuration provisioning engine 604 in the configuration provisioning system 208/600 may then perform configuration transmission operations 2002 that include transmitting each of those configurations via its wired communication subsystem 608 and via the network 210 to the computing device 800, 802, or 804 for which that configuration was identified.

For example, at block 712, the configuration provisioning engine 604 may use the computing device identification information (i.e., the base MAC address, service tag, serial number, or other computing device identification information of that computing device) for each computing device 800, 802, and 804 to transmit the configuration identified for that computing device to that computing device, and one of skill in the art in possession of the present disclosure will appreciate how the transmission of a configuration to a computing device at block 712 operates to configure that computing device with that configuration due to that computing device being configured to perform zero-touch provisioning techniques that automatically configure that computing device with that configuration upon receiving it.

Following block 712, the method 700 returns to block 706. As such, the method 700 may loop such the configuration provisioning system 208/600 configures computing devices with configurations identified based on their locations following verification that those computing device have capabilities that support their configuration. However, one of skill in the art in possession of the present disclosure will appreciate that embodiments in which optional decision block 708 and optional block 710 are omitted, the method 700 may loop such that the configuration provisioning system 208/600 configures computing devices with configurations identified based on their locations until all of the computing devices at the different locations in the location-based zero-touch provisioning system are configured.

As will be appreciated by one of skill in the art in possession of the present disclosure, in addition to simplifying the initial configuration of computing devices provided at locations in the location-based zero-touch provisioning system, the location-based zero-touch provisioning system of the present disclosure also provides substantial benefits with the replacement of computing devices provided at locations in the location-based zero-touch provisioning system. For example, in the event one of the computing devices 800, 802, or 804 becomes unavailable, that computing device may be removed from its location and replaced at that location with a replacement computing device, and the method 700 may operate substantially as described above to cause the location information for that replacement computing device to be provided to the configuration provisioning system 208/600 so that the configuration provisioning system 208/600 may identify a configuration for that replacement computing device and provide it to that replacement computing device to configure that replacement computing device with that configuration (without the need to map the identity of that replacement computing device to that configuration in the configuration provisioning system 208/600).

Thus, systems and methods have been described that identify configurations for computing devices based on the physical locations of those computing device. For example, the location-based zero-touch provisioning system of the present disclosure may include a first computing device that is located at a first location, and a configuration provisioning system that is coupled to the first computing device. The configuration provisioning system receives first location information from the first computing device identifying the first location of the first computing device. The configuration provision system then identifies a first configuration that is mapped to the first location information in a configuration/location mapping included in a configuration provisioning database. The configuration provisioning system then provides the first configuration to the first computing device to configure the first computing device with the first configuration. As such, any computing device may be configured in a particular manner based on its particular physical location and without the need to map the identity of that computing device to its configuration.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A location-based zero-touch provisioning system, comprising:
a first computing device that is located at a first location; and
a configuration provisioning system that is coupled to the first computing device, wherein the configuration provisioning system is configured to:
receive, from the first computing device, first location information identifying the first location of the first computing device;
identify, in a configuration/location mapping included in a configuration provisioning database, a first configuration that is mapped to the first location information; and
provide, to the first computing device, the first configuration to configure the first computing device with the first configuration.

2. The system of claim 1, further comprising:
a second computing device that is coupled to the configuration provisioning system and that is located at a second location that is different than the first location, wherein the configuration provisioning system is configured to:
receive, from the second computing device, second location information identifying the second location of the second computing device;
identify, in a configuration/location mapping included in a configuration provisioning database, a second configuration that is mapped to the second location; and
provide, to the second computing device, the second configuration to configure the second computing device with the second configuration.

3. The system of claim 1, the configuration provisioning system is configured to:
retrieve, from the first computing device, first capability information identifying at least one capability of the first computing device; and
verify that the at least one capability of the first computing device supports the first configuration prior to providing the first configuration to the first computing device to configure the first computing device with the first configuration.

4. The system of claim 1, wherein the configuration provisioning system is configured to:
transmit, to the first computing device, a nonce;
receive, from the first computing device, a first communication that is encrypted using a private key of the first wireless communication subsystem;
decrypt, using a public key of the first wireless communication subsystem, the first communication; and
determine that the first communication includes the nonce.

5. The system of claim 1, further comprising:
a first wireless communication subsystem that is located at the first location and that is configured to wirelessly receive the first location information from the first computing device and wirelessly transmit the first location information via a network and to the configuration provisioning system.

6. The system of claim 1, further comprising:
a first wireless communication subsystem that is located at the first location and that is configured to wirelessly transmit the first location information to the first computing device, and wherein the first computing device is configured to transmit the first location information via a network to the configuration provisioning system.

7. The system of claim 6, wherein first computing device includes a wireless reader subsystem that is configured to receive a wireless tag that provides the first wireless communication subsystem and, in response, wirelessly read the first location information from the wireless tag.

8. An Information Handling System (IHS), comprising:
a processing system; and
a memory system that is coupled to the processing system and that includes instructions that, when executed by the processing system, cause the processing system to provide a configuration provisioning engine that is configured to:
receive, from a first computing device, first location information identifying a first location at which the first computing device is located;
identify, in a configuration/location mapping included in a configuration provisioning database, a first configuration that is mapped to the first location information; and
provide, to the first computing device, the first configuration to configure the first computing device with the first configuration.

9. The IHS of claim 8, wherein the configuration provisioning engine is configured to:
receive, from a second computing device, second location information identifying a second location at which the second computing device is located;
identify, in a configuration/location mapping included in a configuration provisioning database, a second configuration that is mapped to the second location; and
provide, to the second computing device, the second configuration to configure the second computing device with the second configuration.

10. The IHS of claim 8, wherein the configuration provisioning engine is configured to:
retrieve, from the first computing device, first capability information identifying at least one capability of the first computing device; and
verify that the at least one capability of the first computing device supports the first configuration prior to providing the first configuration to the first computing device to configure the first computing device with the first configuration.

11. The IHS of claim 8, wherein the configuration provisioning engine is configured to:
transmit, to the first computing device, a nonce;
receive, from the first computing device, a first communication that is encrypted using a private key of the first wireless communication subsystem;
decrypt, using a public key of the first wireless communication subsystem, the first communication; and
determine that the first communication includes the nonce.

12. The IHS of claim 8, further comprising:
a first wireless communication subsystem that is located at the first location, that is coupled to the processing system, and that is configured to wirelessly receive the first location information from the first computing device and wirelessly transmit the first location information via a network and to the configuration provisioning engine.

13. The IHS of claim 8, further comprising:
a first wireless communication subsystem that is located at the first location and that is configured to wirelessly transmit the first location information to the first computing device, and wherein the first computing device is configured to transmit the first location information via a network to the configuration provisioning engine.

14. A method for performing zero-touch provisioning of computing devices based on locations of those computing devices, comprising:
receiving, by a configuration provisioning system from a first computing device, first location information identifying a first location at which the first computing device is located;
identifying, by the configuration provisioning system in a configuration/location mapping included in a configuration provisioning database, a first configuration that is mapped to the first location information; and
providing, by the configuration provisioning system to the first computing device, the first configuration to configure the first computing device with the first configuration.

15. The method of claim 14, further comprising:
receiving, by the configuration provisioning system from a second computing device, second location information identifying a second location at which the second computing device is located;
identifying, by the configuration provisioning system in a configuration/location mapping included in a configuration provisioning database, a second configuration that is mapped to the second location; and
providing, by the configuration provisioning system to the second computing device, the second configuration to configure the second computing device with the second configuration.

16. The method of claim 14, further comprising:
retrieving, by the configuration provisioning system from the first computing device, first capability information identifying at least one capability of the first computing device; and
verifying, by the configuration provisioning system, that the at least one capability of the first computing device supports the first configuration prior to providing the first configuration to the first computing device to configure the first computing device with the first configuration.

17. The method of claim 14, further comprising:
transmitting, by the configuration provisioning system to the first computing device, a nonce;
receiving, by the configuration provisioning system from the first computing device, a first communication that is encrypted using a private key of the first wireless communication subsystem;
decrypting, by the configuration provisioning system using a public key of the first wireless communication subsystem, the first communication; and
determining, by the configuration provisioning system, that the first communication includes the nonce.

18. The method of claim 14, further comprising:
wirelessly receiving, by a first wireless communication subsystem that is located at the first location and coupled to the configuration provisioning system, the first location information from the first computing device; and
wirelessly transmitting, by the first wireless communication subsystem, the first location information via a network and to the configuration provisioning system.

19. The method of claim 14, further comprising:
wirelessly transmitting, by a first wireless communication subsystem that is located at the first location, the first location information to the first computing device; and
transmitting, by the first computing device, the first location information via a network to the configuration provisioning system.

20. The method of claim 19, further comprising:
receiving, by a wireless reader subsystem included in the first computing device, a wireless tag that provides the first wireless communication subsystem; and
wirelessly reading, by the wireless reader subsystem in response to receiving the wireless tag, the first location information from the wireless tag.
